(19) United States
(12) Patent Application Publication
(10) Pub. No.: US 2022/0264148 A1
(43) Pub. Date: Aug. 18, 2022

(54) Sample Value Clipping on MIP Reduced Prediction

(71) Applicant: Telefonaktiebolaget LM Ericsson (publ), Stockholm (SE)

(72) Inventors: Zhi Zhang, Solna (SE); Ruoyang Yu, Täby (SE); Kenneth Andersson, Gävle (SE); Per Wennersten, Årsta (SE); Jacob Ström, Stockholm (SE); Rickard Sjöberg, Stockholm (SE)

(21) Appl. No.: 17/617,727

(22) PCT Filed: Jun. 12, 2020
(86) PCT No.: PCT/SE2020/050614

§ 371 Date: Dec. 9, 2021

Related U.S. Application Data
(60) Provisional application No. 62/861,576, filed on Jun. 14, 2019.

(51) Int. Cl. H04N 19/593; H04N 19/132; H04N 19/159; H04N 19/176

(52) U.S. Cl. CPC H04N 19/593; H04N 19/176; H04N 19/159; H04N 19/132

(57) ABSTRACT

Intra-prediction with modified clipping is presented herein for encoding and/or decoding video and/or still images. Input boundary samples for a current block are used to generate a reduced prediction matrix of prediction samples. Clipping is performed on each of the prediction samples in the reduced prediction matrix that are out of range to generate a clipped reduced prediction matrix. The clipped reduced prediction matrix is then used to generate the complete prediction block corresponding to the current block. The prediction block is then used to obtain a residual block. By clipping the prediction sample(s) in the reduced prediction matrix, the solution presented herein reduces latency and complexity.

### RELATED APPLICATION

This application claims priority to U.S. Application No. 62/861,576 filed 14 Jun. 2019, the disclosure of which is incorporated in its entirety by reference herein.

### TECHNICAL FIELD

The present disclosure relates generally to block based video/image coding and, more particularly, to matrix based intra-prediction used in block based video/image coding with reduced complexity and/or latency.

### BACKGROUND

High Efficiency Video Coding (HEVC) is a block-based video codec standardized by International Telecommunication Union-Telecommunication (ITU-T) and the Moving Pictures Expert Group (MPEG) that utilizes both temporal and spatial prediction. Spatial prediction is achieved using intra (I) prediction from within the current picture. Temporal prediction is achieved using uni-directional (P) or bi-directional inter (B) prediction on a block level from previously decoded reference pictures. In the encoder, the difference between the original pixel data and the predicted pixel data, referred to as the residual, is transformed into the frequency domain, quantized, and then entropy coded before transmission together with necessary prediction parameters, such as prediction mode and motion vectors, which are also entropy coded. The decoder performs entropy decoding, inverse quantization, and inverse transformation to obtain the residual, and then adds the residual to an intra- or inter-prediction to reconstruct an image.

MPEG and ITU-T is working on the successor to HEVC within the Joint Video Exploratory Team (JVET). The name of the video codec under development is Versatile Video Coding (VVC). At the time of this filing, the current version of the VVC draft specification was “Versatile Video Coding (Draft 5),” JVET-N1001-v3.

Matrix based intra-prediction is a coding tool that is included in the current version of the VVC draft. For predicting the samples of a current block of width W and height H, matrix-based intra-prediction (MIP) takes one column of H reconstructed neighboring boundary samples to the left of the current block and one row of W reconstructed neighboring samples above the current block as input. The predicted samples are derived by downsampling the original boundary samples to obtain a set of reduced boundary samples, matrix multiplication of the reduced boundary samples to obtain a subset of the prediction samples in the prediction block, and linear interpolation of the subset of the prediction samples to obtain the remaining prediction samples in the prediction block.

The reduced boundary samples are derived by averaging samples from original boundaries. The process to derive the averages requires addition and shift operations which increase the decoder and encoder computational complexity and latency, especially for hardware implementations. In the current version of VVC, the maximum dimension of a block which is predicted by MIP is 64×64. To derive one sample of the reduced boundary, the maximum number of original samples used in the average operation is 64/4=16. The computational complexity for this average operation is 16 additions and 1 shift.

Further, when the matrix multiplication produces a reduced prediction block comprising a subset of the prediction samples in the final prediction block, linear interpolation is used to obtain the remaining prediction samples. In this case, an intermediate reduced boundary is used for interpolating the prediction samples in the first row and/or column of the prediction block. In this case, the reduced boundary samples for the top and/or left boundaries are derived from the intermediate reduced boundary. This two-step derivation process for the reduced boundary increases the encoder and decoder latency.

Another drawback to using MIP is that the boundary samples in the reduced boundary used as input for the matrix multiplication unit (MMU) do not align with the MMU output. The process for averaging the boundary samples yields values centered between two original boundary samples and biased towards certain ones of the MIP outputs. A similar problem also exists for boundary samples used for linear interpolation.

A further drawback to MIP is that the matrix multiplication may produce out of bound prediction samples, e.g., negative prediction samples and/or prediction samples exceeding a maximum value. Conventional clipping operations may cause undesirable latency and/or complexity. As such, there remains a need for improved intra-prediction used for coding images.

### SUMMARY

Intra-prediction with modified clipping is used for encoding and/or decoding video and/or still images. Input boundary samples for a current block are used to generate a reduced prediction matrix of prediction samples. Clipping is performed on each of the prediction samples in the reduced prediction matrix that are out of range to generate a clipped reduced prediction matrix. The clipped reduced prediction matrix is then used to generate the complete prediction block corresponding to the current block. The prediction block is then used to obtain a residual block. By clipping the prediction sample(s) in the reduced prediction matrix, the solution presented herein reduces latency and complexity.

One aspect of the solution presented herein comprises a method of intra-prediction associated with a current block. The method comprises deriving a reduced prediction matrix from input boundary samples adjacent the current block. The reduced prediction matrix has a number of prediction samples less than the size of a prediction block for the current block. The method further comprises clipping each prediction sample in the reduced prediction matrix having a value outside a predetermined range to generate a clipped reduced prediction matrix. The method further comprises deriving the prediction block for the current block from the clipped reduced prediction matrix, said prediction block having a number of prediction samples equal to the size of the prediction block for the current block.

One aspect of the solution presented herein comprises an intra-prediction apparatus for performing intra-prediction associated with a current block. The intra-prediction apparatus comprises a matrix multiplication unit (MMU), a clipping unit, and an output unit. Each of these units may be implemented as a circuit and/or a module. The MMU is configured to generate a reduced prediction matrix from input boundary samples adjacent the current block. The reduced prediction matrix has a number of prediction samples less than the size of a prediction block for the current block. The clipping unit is configured to clip each prediction sample in the reduced prediction matrix having a value outside a predetermined range to generate a clipped reduced prediction matrix. The output unit is configured to derive a prediction block for the current block from the clipped reduced prediction matrix, said prediction block having a number of prediction samples equal to the size of the prediction block for the current block.

One exemplary aspect of the solution presented herein comprises a computer program product for controlling a prediction unit. The computer program product comprises software instructions which, when run on at least one processing circuit in the prediction unit, causes the prediction unit to derive a reduced prediction matrix from input boundary samples adjacent the current block. The reduced prediction matrix has a number of prediction samples less than the size of a prediction block for the current block. The software instructions, when run on at least one processing circuit in the prediction unit further causes the prediction unit to clip each prediction sample in the reduced prediction matrix having a value outside a predetermined range to generate a clipped reduced prediction matrix, and derive the prediction block for the current block from the clipped reduced prediction matrix, where the prediction block has a number of prediction samples equal to the size of the prediction block for the current block. In some exemplary embodiments, a computer-readable medium comprises the computer program product. In some exemplary embodiments, the computer-readable medium comprises a non-transitory computer readable medium.

One exemplary aspect comprises a method of encoding comprising intra-prediction, which comprises deriving a reduced prediction matrix from input boundary samples adjacent the current block, where the reduced prediction matrix has a number of prediction samples less than the size of a prediction block for the current block, clipping each prediction sample in the reduced prediction matrix having a value outside a predetermined range to generate a clipped reduced prediction matrix, and deriving the prediction block for the current block from the clipped reduced prediction matrix, said prediction block having a number of prediction samples equal to the size of the prediction block for the current block. The method of encoding further comprises subtracting the prediction block from the current block to generate a residual block, determining an encoded block from the residual block, and transmitting the encoded block to a receiver.

One exemplary aspect comprises a method of decoding comprising intra-prediction, which comprises deriving a reduced prediction matrix from input boundary samples adjacent the current block, where the reduced prediction matrix has a number of prediction samples less than the size of a prediction block for the current block, clipping each prediction sample in the reduced prediction matrix having a value outside a predetermined range to generate a clipped reduced prediction matrix, and deriving the prediction block for the current block from the clipped reduced prediction matrix, said prediction block having a number of prediction samples equal to the size of the prediction block for the current block. The method of decoding further comprises receiving an encoded block from a transmitter, determining a residual block from the received encoded block, and combining the residual block with the prediction block to determine a decoded block representative of the current block.

One exemplary aspect comprises an encoder comprising an intra-prediction apparatus, a combiner, and a processing circuit. The intra-prediction apparatus is configured to derive a reduced prediction matrix from input boundary samples adjacent the current block, where the reduced prediction matrix has a number of prediction samples less than the size of a prediction block for the current block, clip each prediction sample in the reduced prediction matrix having a value outside a predetermined range to generate a clipped reduced prediction matrix, and derive the prediction block for the current block from the clipped reduced prediction matrix, said prediction block having a number of prediction samples equal to the size of the prediction block for the current block. The combiner is configured to subtract the prediction block from the current block to generate a residual block. The processing circuit is configured to determine an encoded block from the residual block for transmission by a transmitter.

One exemplary aspect comprises a decoder comprising an intra-prediction apparatus, a processing circuit, and a combiner. The intra-prediction apparatus is configured to derive a reduced prediction matrix from input boundary samples adjacent the current block, where the reduced prediction matrix has a number of prediction samples less than the size of a prediction block for the current block, clip each prediction sample in the reduced prediction matrix having a value outside a predetermined range to generate a clipped reduced prediction matrix, and derive the prediction block for the current block from the clipped reduced prediction matrix, said prediction block having a number of prediction samples equal to the size of the prediction block for the current block, The processing circuit is configured to determine a residual block from a received encoded block. The combiner is configured to combine the residual block with the prediction block to determine a decoded block representative of the current block.

### BRIEF DESCRIPTION OF THE DRAWINGS

FIG. 1 shows an exemplary video transmission system using MIP as herein described.

FIG. 2 shows an exemplary encoder configured to implement MIP as herein described.

FIG. 3 shows an exemplary decoder configured to implement MIP as herein described.

FIG. 4 shows MIP for a 4×4 prediction block.

FIG. 5 shows MIP for a 4×16 prediction block.

FIG. 6 shows MIP for an 8×8 prediction block.

FIG. 7 shows MIP for an 8×8 prediction block.

FIG. 8 shows MIP for a 16×8 prediction block.

FIG. 9 shows MIP for a 16×16 prediction block.

FIG. 10 shows a method of MIP implemented by a prediction unit in an encoder or decoder.

FIG. 11 shows downsampling input boundary samples without averaging to derive the top interpolation boundary samples for vertical linear interpolation.

FIG. 12 shows downsampling input boundary samples without averaging to derive the left interpolation boundary samples for horizontal linear interpolation.

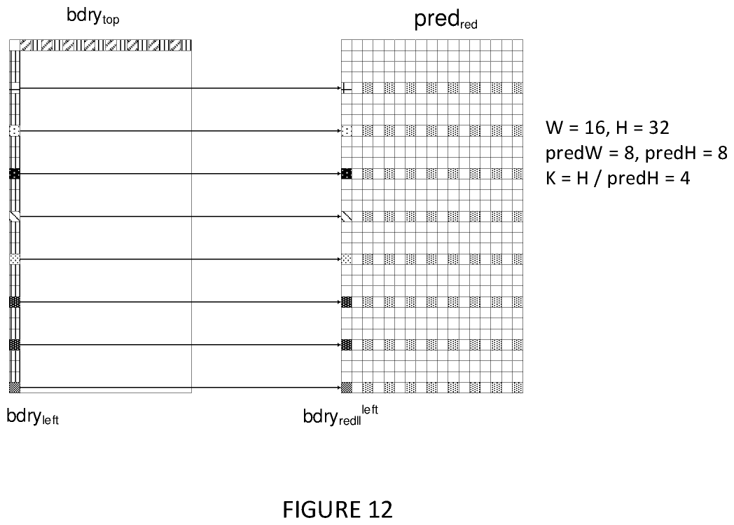

FIG. 13 shows downsampling input boundary samples without averaging to derive the reduced boundary samples for matrix multiplication.

FIG. 14 shows downsampling input boundary samples without averaging to derive the reduced boundary samples for matrix multiplication.

FIG. 15 shows downsampling input boundary samples without averaging to derive the reduced boundary samples for both matrix multiplication and linear interpolation.

FIG. 16 shows one-step downsampling input boundary samples using averaging to derive reduced boundary samples for matrix multiplication.

FIG. 17 shows misalignment between reduced boundary samples for interpolation and the MMU output.

FIG. 18 shows another exemplary method of MIP according to one embodiment.

FIG. 19 shows an exemplary prediction unit for MIP.

FIG. 20 shows a comparison between a current VVC process and the VVC process according to the solution presented herein.

FIG. 21 shows an encoding or decoding device configured to perform MIP as herein described.

### DETAILED DESCRIPTION

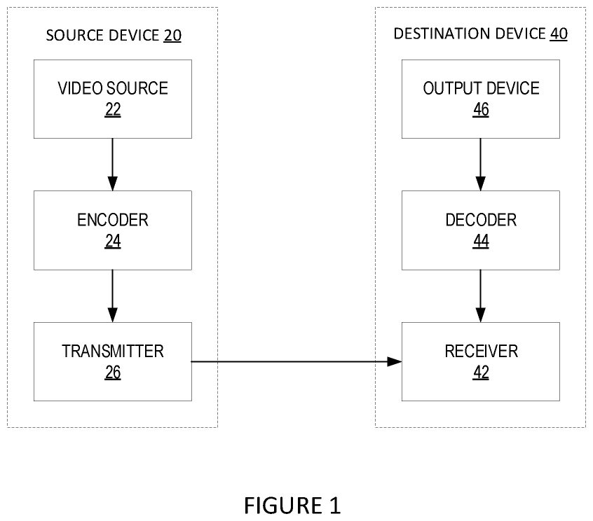

The present disclosure will be explained in the context of a video transmission system 10 as shown in FIG. 1. Those skilled in the art will appreciate that the video transmission system 10 in FIG. 1 is used herein for purposes of explaining the principles of the present disclosure and that the techniques herein are not limited to the video transmission system 10 of FIG. 1, but are more generally applicable to any block based video transmission system using matrix based intra-prediction (MIP). Further, while the following describes MIP in terms of video coding, it will be appreciated that the MIP disclosed herein equally applies to coding of still images.

The video transmission system 10 includes a source device 20 and destination device 40. The source device 20 generates coded video for transmission to the destination device 40. The destination device 40 receives the coded video from the source device 20, decodes the coded video to obtain an output video signal, and displays or stores the output video signal.

The source device 20 includes an image source 22, encoder 24, and transmitter 26. Image source 22 may, for example, comprise a video capture device, such as a video camera, playback device or a video storage device. In other embodiments, the image source 22 may comprise a computer or processing circuitry configured to produces computer-generated video. The encoder 24 receives the video signal from the video source 22 and generates an encoded video signal for transmission. The encoder 24 is configured to generate one or more coded blocks as hereinafter described. To encode a current block, the encoder 24 uses boundary samples from neighboring blocks stored in memory 38. The transmitter 26 is configured to transmit the coded blocks as a video signal to the destination device 30 over a wired or wireless channel 15. In one embodiment, the transmitter 26 comprises part of a wireless transceiver configured to operate according to the long-term evolution (LTE) or New Radio (NR) standards.

The destination device 40 comprises a receiver 42, decoder 44, and output device 46. The receiver 42 is configured to receive the coded blocks in a video signal transmitted by the source device 20 over a wired or wireless channel 15. In one embodiment, the receiver 42 is part of a wireless transceiver configured to operate according to the LTE or NR standards. The encoded video signal is input to the decoder 44, which is configured to implement MIP to decode one or more coded blocks contained within the encoded video signal to generate an output video that reproduces the original video encoded by the source device 20. To decode a current block, the decoder 44 uses boundary samples from neighboring blocks stored in memory 58. The output video is output to the output device 26. The output device may comprise, for example, a display, printer or other device for reproducing the video, or data storage device.

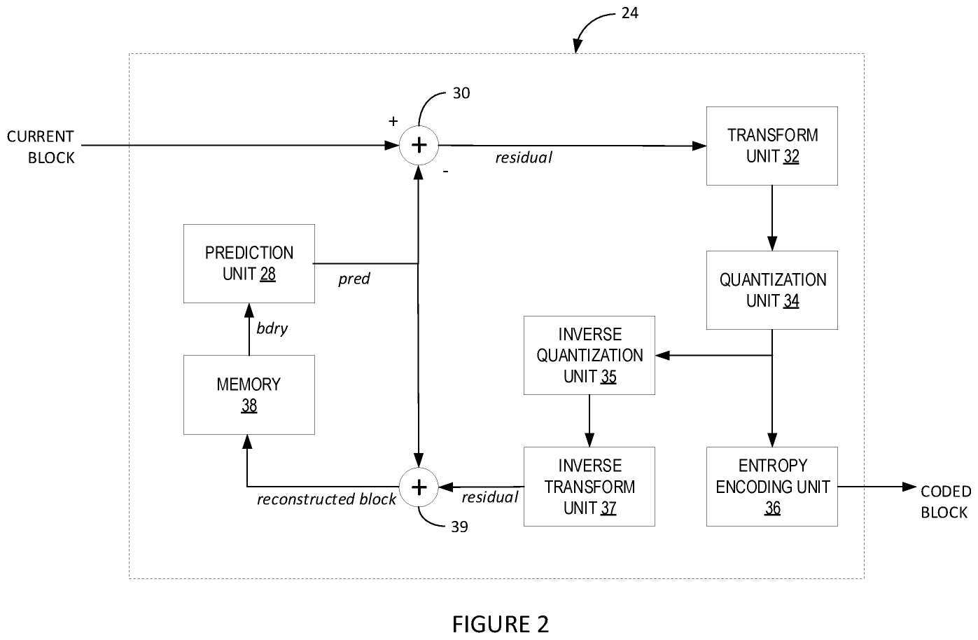

FIG. 2 shows an exemplary encoder 24 according to an embodiment. Encoder 24 comprises processing circuitry configured to perform MIP. The main functional components of the encoder 24 include a prediction unit 28, subtracting unit 30, transform unit 32, quantization unit 34, entropy encoding unit 36, an inverse quantization unit 35, an inverse transform unit 37, and a summing unit 39. The components of the encoder 24 can be implemented by hardware circuits, microprocessors, or a combination thereof. A current block is input to the subtraction unit 30, which subtracts a prediction block output by the prediction unit 28 from the current block to obtain the residual block. The residual block is transformed to a frequency domain by the transform unit 32 to obtain a two-dimensional block of frequency domain residual coefficients. The frequency domain residual coefficients are then quantized by the quantization unit 34 and entropy encoded by the entropy encoding unit 36 to generate the encoded video signal. The quantized residual coefficients are input to the inverse quantization unit 35, which de-quantizes to reconstruct the frequency domain residual coefficients. The reconstructed frequency domain residual coefficients are then transformed back to the time domain by inverse transform unit and added to the prediction block output by the prediction unit 28 by the summing unit 39 to obtain a reconstructed block that is stored in memory 38. The reconstructed blocks stored in memory 38 provide the input boundary samples used by the prediction unit 28 for MIP.

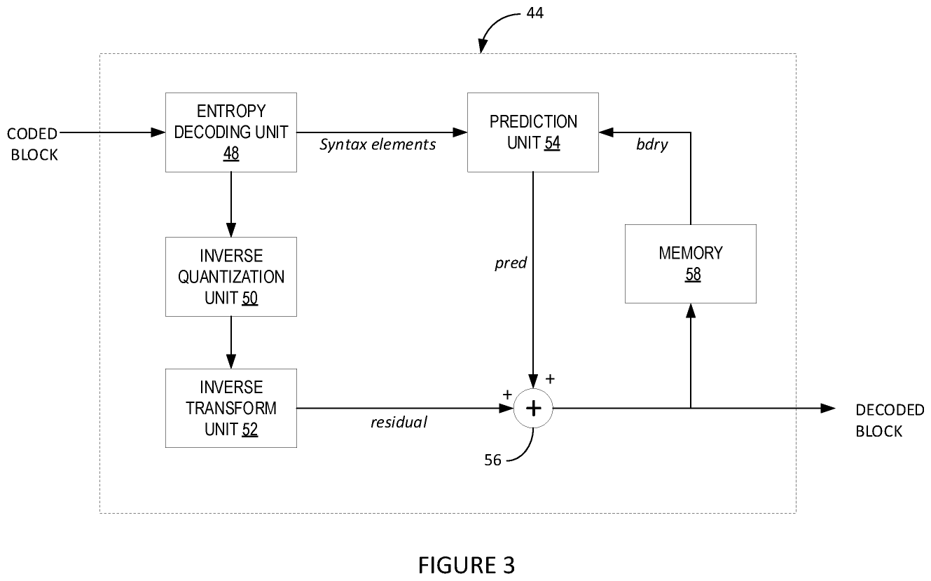

FIG. 3 shows an exemplary decoder 44 configured to perform intra-prediction as herein described. The decoder 44 includes an entropy decoding unit 48, inverse quantization unit 50, inverse transform unit 52, prediction unit 54, and summing unit 56. The entropy decoding unit 48 decodes a current block to obtain a two-dimensional block of quantized residual coefficients and provides syntax information to the prediction unit 54. The inverse quantization unit 50 performs inverse quantization to obtain de-quantized residual coefficients and the inverse transform unit 52 performs an inverse transformation of the de-quantized residual coefficients to obtain an estimate of the transmitted residual coefficients. The prediction unit 54 performs intra-prediction as herein described to generate a prediction block for the current block. The summing unit 56 adds the prediction block from the prediction unit 54 and the residual values output by the inverse transform unit 52 to obtain the output video.

The encoder 24 or decoder 44 are each configured to perform intra-prediction to encode and decode video. A video sequence comprises a series of pictures where each picture comprises one or more components. Each component can be described as a two-dimensional rectangular array of sample values. It is common that a picture in a video sequence comprises three components; one luma component Y where the sample values are luma values, and two chroma components Cb and Cr, where the sample values are chroma values. It is common that the dimensions of the chroma components are smaller than the luma components by a factor of two in each dimension. For example, the size of the luma component of a High Definition (HD) picture can be 1920×1080 and the chroma components can have the dimension of 960×540. Components are sometimes referred to as color components. In the following methods and apparatus useful for the encoding and decoding of video sequences are described. However, it should be understood that the techniques described can also be used for encoding and decoding of still images.

HEVC and VVC are examples of block based video coding techniques. A block is a two-dimensional array of samples. In video coding, each component is split into blocks and the coded video bit stream is a series of blocks. It is common in video coding that the picture is split into units that cover a specific area. Each unit comprises all blocks that make up that specific area and each block belongs fully to only one unit. The coding unit (CU) in HEVC and VVC is an example of such a unit. A coding tree unit (CTU) is a logical unit which can be split into several CUs. In HEVC, CUs are squares, i.e., they have a size of N×N luma samples, where N can have a value of 64, 32, 16, or 8. In the current H.266 test model Versatile Video Coding (VVC), CUs can also be rectangular, i.e., have a size of N×M luma samples where N is different from M.

Spatial and temporal prediction can be used to eliminate redundancy in the coded video sequence. Intra-prediction predicts blocks in a picture based on spatial extrapolation of samples from previously decoded blocks of the same (current) picture. Intra-prediction can also be used in video compression, i.e., compression of still videos where there is only one picture to compress/decompress. Inter-prediction predicts blocks by using samples for previously decoded pictures. This disclosure relates to intra-prediction.

Before discussing the specific changes to MIP, e.g., clipping operations, provided by the solution presented herein, the following first generally discusses intra-predication.

Intra directional prediction is utilized in HEVC and VVC. In HEVC, there are 33 angular modes and 35 modes in total. In VVC, there are 65 angular modes and 67 modes in total. The remaining two modes, “planar” and “DC” are non-angular modes. Mode index 0 is used for the planar mode, and mode index 1 is used for the DC mode. The angular prediction mode indices range from 2 to 34 for HEVC and from 2 to 66 for VVC. Intra directional prediction is used for all components in the video sequence, i.e. luma component Y, chroma components Cb and Cr.

In exemplary embodiments of the disclosure, the prediction unit 28, 54 at the encoder 24 or decoder 44, respectively, is configured to implement MIP to predict samples of the current block. MIP is a coding tool that is included in the current version of the VVC draft. For predicting the samples of a current block of width W and height H, MIP takes one column of H reconstructed neighboring boundary samples to the left of the current block and one row of W reconstructed neighboring samples above the current block as input. The predicted samples are derived as follows:
For each boundary (bdryₜₒₚ and bdry_{left}), reduced boundary samples are extracted by averaging the input boundary samples depending on the current block dimension. The extracted averaged boundary samples are denoted as the reduced boundary bdry_{red}.
A matrix vector multiplication is carried out with the extracted averaged boundary samples as input. The output is a reduced prediction signal consisting of a set of predicted sample values where each predicted sample corresponds to a position in the current block, and where the set of positions is a subset of all positions of the current block. The output reduced prediction signal is named as pred_{red}.
The prediction sample values for the remaining positions in the current block that is not in the set of positions are generated from the reduced prediction signal by linear interpolation which is a single step linear interpolation in each direction (vertical and horizontal). The prediction signal comprises all prediction sample values for the block.
   If H>W, the horizontal linear interpolation is first applied by using the reduced left boundary samples which are named as bdryred_{left} or bdry_{redll}^{left} depending on the current block dimension. A vertical linear interpolation is applied after horizontal linear interpolation by using the original top boundary bdryₜₒₚ.
   If H≤W, the vertical linear interpolation is first applied by using the reduced top boundary samples which are named as bdry_{red}^{top} or bdry_{redll}^{top} depending on the current block dimension. A horizontal linear interpolation is applied after vertical linear interpolation by using the original left boundary bdry_{left}.
The predicted samples are finally derived by clipping on each sample of the prediction signal. In the solution presented herein, the samples of the reduced prediction block can be clipped before interpolation.

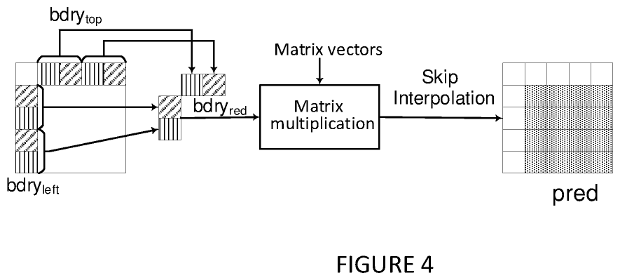

FIG. 4 shows an example of MIP for a 4×4 block. Given a 4×4 block, the bdry_{red} contains 4 samples which are derived from averaging every two samples of each boundary. The dimension of pred_{red} is 4×4, which is same as the current block. Therefore, the horizontal and vertical linear interpolation can be skipped.

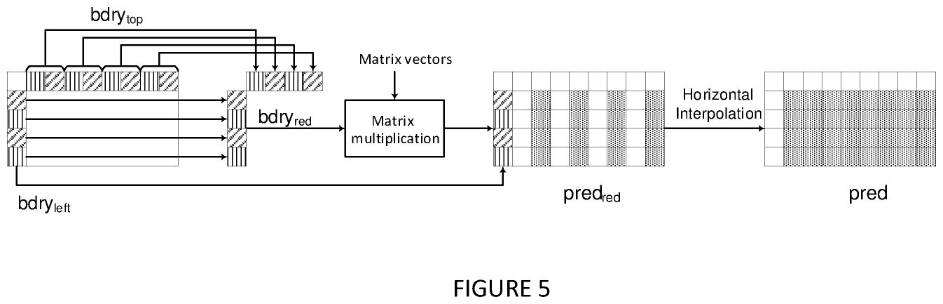

FIG. 5 shows an example of MIP for an 8×4 block. Given an 8×4 block, the bdry_{red} contains 8 samples which are derived from the original left boundary and averaging every two samples of the top boundary. The dimension of pred_{red} is 4×4. The prediction signal at the remaining positions is generated from the horizontal linear interpolation by using the original left boundary bdry_{left}.

Given a W×4 block, where W≥16, the bdry_{red} contains 8 samples which are derived from the original left boundary and averaging every W/4 samples of the top boundary. The dimension of pred_{red} is 8×4. The prediction signal at the remaining positions is generated from the horizontal linear interpolation by using the original left boundary bdryₑf.

Given a 4×8 block, the bdry_{red} contains 8 samples which are derived from averaging every two samples of the left boundary and the original top boundary. The dimension of pred_{red} is 4×4. The prediction signal at the remaining positions is generated from the vertical linear interpolation by using the original top boundary bdryₜop.

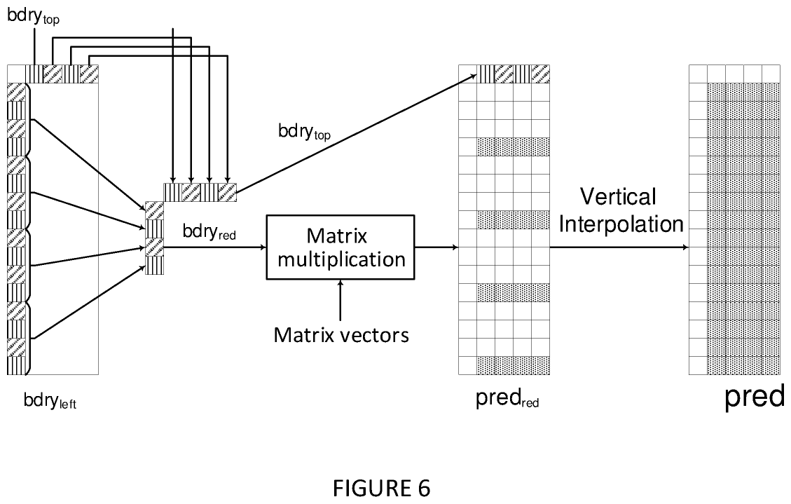

Given a 4×H block, where H≥16, the bdry_{red} contains 8 samples which are derived from averaging every H/4 samples of the left boundary and the original top boundary. The dimension of pred_{red} is 4×8. The prediction signal at the remaining positions is generated from the vertical linear interpolation by using the original top boundary bdryₜop. FIG. 6 shows an example of MIP process for a 4×16 block.

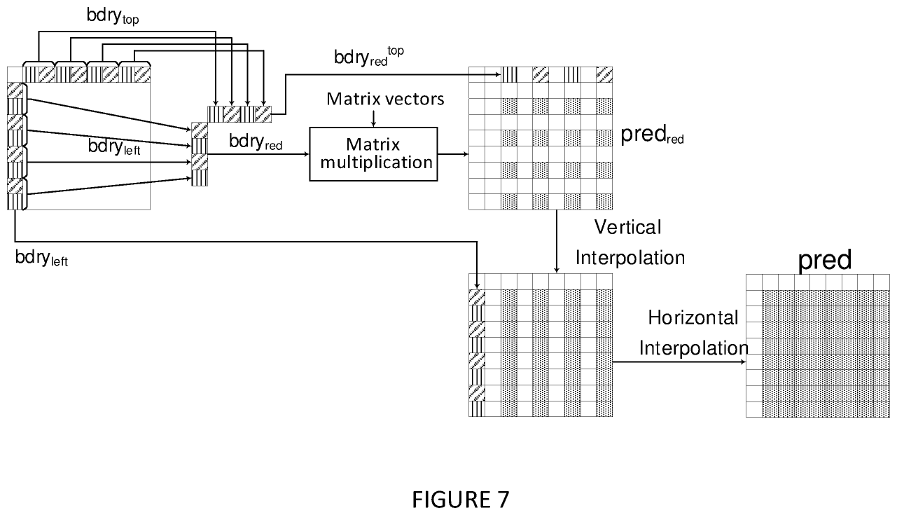

Given an 8×8 block, the bdry_{red} contains 8 samples which are derived from averaging every two samples of each boundary. The dimension of pred_{red} is 4×4. The prediction signal at the remaining positions is generated from first the vertical linear interpolation by using the reduced top boundary bdry_{red}^{top}, secondly the horizontal linear interpolation by using the original left boundary bdry_{left}. FIG. 7 shows an example of the MIP process for an 8×8 block.

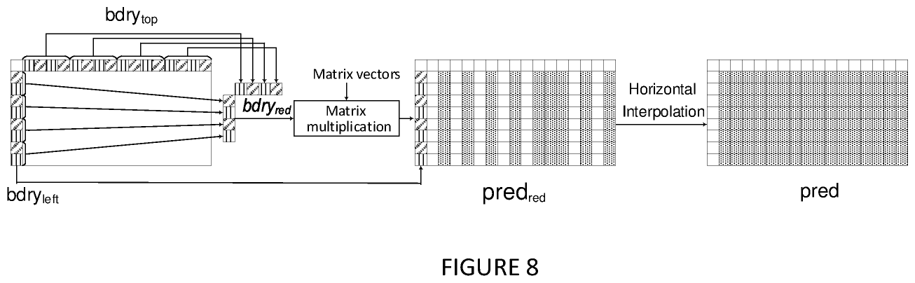

Given a W×8 block, where W≥16, the bdry_{red} contains 8 samples which are derived from averaging every two samples of left boundary and averaging every W/4 samples of top boundary. The dimension of pred_{red} is 8×8. The prediction signal at the remaining positions is generated from the horizontal linear interpolation by using the original left boundary bdry_{left}. FIG. 8 shows an example of MIP process for a 16×8 block.

Given an 8×H block, where H≥16, the bdry_{red} contains 8 samples which are derived from averaging every H/4 samples of the left boundary and averaging every two samples of the top boundary. The dimension of pred_{red} is 8×8. The prediction signal at the remaining positions is generated from the vertical linear interpolation by using the original top boundary bdryₜₒₚ.

Given a W×H block, where W≥16 and H≥16, the bdry_{red} contains 8 samples which are derived as follows:
For H≤W, first, bdry_{redll}^{top} contains 8 samples that are derived by averaging every W/8 samples of top boundary. Secondly, bdry_{red} contains 8 samples are derived from averaging every H/4 samples of the left boundary and averaging every two samples of the bdry_{redll}^{top}.
For H>W, first bdry_{redll}^{left} contains 8 samples are derived by averaging every H/8 samples of left boundary. Secondly, the bdry_{red} contains 8 samples are derived from averaging every two of the bdry_{redll}^{left} and every W/4 samples of the top boundary.

The dimension of pred_{red} is 8×8. The prediction signal at the remaining positions is generated by using linear interpolation as follows:
For H≤W, first the vertical linear interpolation by using the reduced top boundary samples bdry_{redll}^{top}, which are derived by averaging every W/8 samples of top boundary, secondly the horizontal linear interpolation by using the original left boundary bdry_{left}.
For H>W, first the horizontal linear interpolation by using the reduced left boundary samples bdry_{redll}^{left}, which are derived by averaging every H/8 samples of top boundary, secondly the vertical linear interpolation by using the original top boundary bdryₜₒₚ.

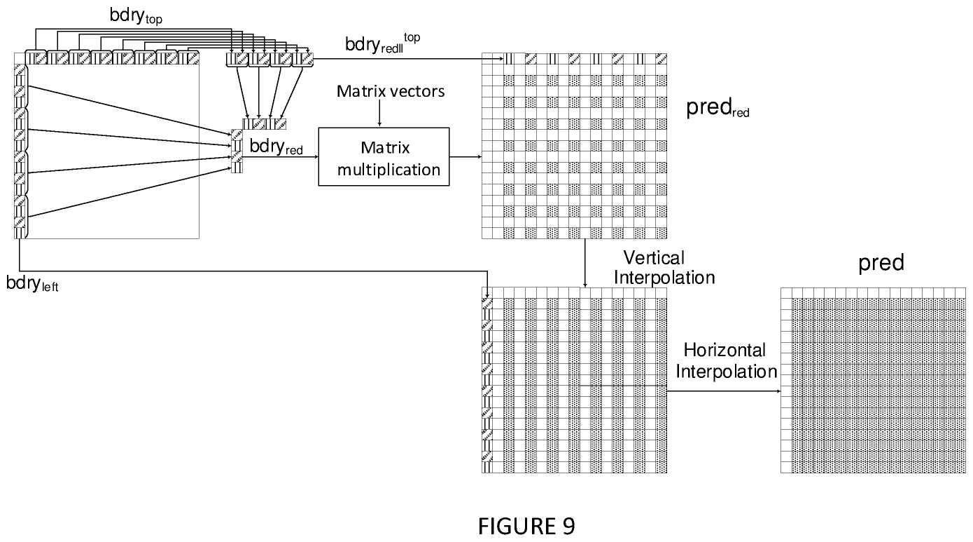

FIG. 9 shows an example MIP process for a 16×16 block.

In the current version of VVC, the MIP is applied for luma component.

The MIP process as described above has a number of drawbacks. The reduced boundary bdry_{red} samples are derived by averaging samples from original boundaries bdry_{left} and bdryₜₒₚ. The samples average requires addition operations and shift operations which would increase the decoder and encoder computational complexity and latency, especially for hardware implementations. In the current version of VVC, the maximum dimension of a block which is predicted by MIP is 64×64. To derive one sample of the bdry_{red}, the maximum number of original samples used in the average operation is 64/4=16. The computational complexity for this average operation is 16 additions and 1 shift.

Further, when the matrix multiplication produces a reduced prediction block comprising a subset of the prediction samples in the final prediction block, linear interpolation is used to obtain the remaining prediction samples.

Given a W×H block, where both W≥16 and H≥16, the reduced boundary bdry_{red} samples are derived in two steps:
If H≤W, first, bdry_{redll}^{top} contains 8 samples that are derived by averaging every W/8 samples of the top boundary. Secondly, bdry_{red} contains 8 samples that are derived from averaging every H/4 samples of the left boundary and averaging every two samples of the bdry_{redll}^{top}.
If H>W, first the bdry_{redll}^{left} contains 8 samples are derived by averaging every H/8 samples of left boundary. Secondly, the bdry_{red} contains 8 samples are derived from averaging every two of the bdry_{redll}^{left} and every W/4 samples of the top boundary.

The intermediate reduced boundaries bdry_{redll}^{top} and bdry_{redll}^{left} are used for the vertical and horizontal linear interpolation respectively. This two-step derivation process of the reduced boundary bdry_{red} increases the encoder and decoder latency.

One way to reduce latency is to aspect of the present disclosure is to provide techniques that enable alignment of reduced boundary samples used for either matrix multiplication or interpolation with the output of the MMU while maintaining coding efficiency.

Another way to reduce the computational complexity for deriving the reduced boundary samples is by reducing the number of original boundary samples used to derive one reduced boundary sample. Reduction of computational complexity is achieved in some embodiments by reducing the number of input boundary samples that are averaged to generate one reduced boundary sample. For example, the worst case requires reading and averaging 16 input boundary samples to derive one reduced boundary sample. This process requires 16 reads, 15 additions (n−1) and 1 shift. In this example, computational complexity can be reduced by selecting two of the sixteen boundary samples for averaging, which requires two reads, 1 addition and 1 shift. In another embodiment, reduction of computational complexity is achieved by downsampling without averaging. Continuing with the same example, the MIP can be configured to select one of the sixteen original input boundary samples. In this case, only 1 read is required with no addition or shift operations.

Another way to reduce latency is by eliminating the two step derivation process for the reduced boundary samples used as input to the MMU. When the matrix multiplication produces a reduced prediction block comprising a subset of the prediction sample in the final prediction block, linear interpolation is used to obtain the remaining prediction samples. In this case, an intermediate reduced boundary is used for interpolating the prediction samples in the first row and/or column of the prediction block. The reduced boundary samples for the top and/or left boundaries are derived from the intermediate reduced boundary. This two-step derivation process for the reduced boundary increases the encoder and decoder latency. In embodiments of the present disclosure, the reduced boundary samples used for matrix multiplication and interpolation respectively are derived in parallel in a single step.

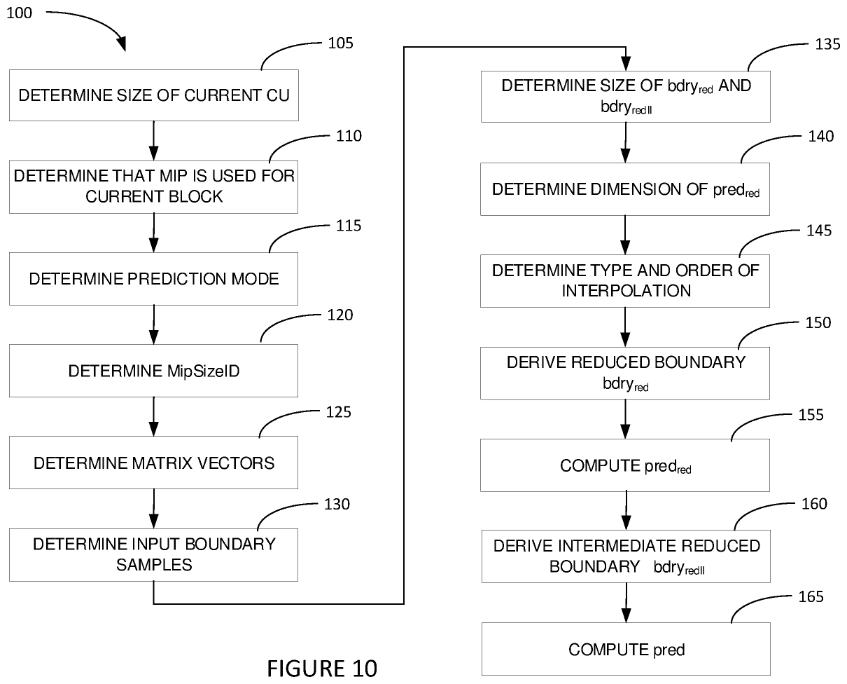

FIG. 10 shows an exemplary method 100 of encoding or decoding using MIP. The encoder/decoder 24, 44 derives the size of the current CU as a width value W and a height value H, determines that the current block is an intra predicted block and derives a prediction mode for the current block (blocks 105-115). At the decoder 44, these determinations are based on syntax elements in the decoded bitstream. Next, the encoder/decoder 24, 44 derives the mipSizeId from the width W and the height H and determines the matrix vectors for the current block from a matrix vector look-up table by using the prediction mode and mipSizeId and as table index (blocks 120 and 125).

Once the block size and matrix vectors are known, the encoder/decoder 24, 44 determines the original boundary sample values for the current block (block 130). The original boundary samples are W samples from the nearest neighboring samples immediately above of the current block and H samples from the nearest neighboring samples to the immediate left of the current block. The values of these samples may be store in memory 38, 58 of the encoder 24 or decoder 44 respectively. The encoder/decoder 24, 44 determines the size of the reduced boundary bdry_{red} and, if necessary, the size of the intermediate reduced boundary bdry_{redll}, (block 135). The encoder/decoder 24, 44 determines the dimension of the reduced prediction signal pred_{red} by the width W and the height H of the current block (block 140). The encoder/decoder 24, 44 also determines whether to apply vertical linear interpolation, horizontal linear interpolation, or both, depending on the width W and height H of the current block (block 145).

For the matrix multiplication, the encoder/decoder 24, 44 derives the reduced boundary bdry_{red} from the original boundary samples as will be hereinafter described in more detail (block 150). The reduced prediction signal pred_{red} is then derived by matrix multiplication of the matrix vector and the reduced boundary bdry_{red} (block 155). When linear interpolation is performed, the encoder/decoder 24, 44 derives the intermediate reduced boundary samples bdry_{redll}, also referred to herein as interpolation boundary samples, from the original boundary samples and performs linear interpolation to derive the remaining samples of the predication block pred based on its determination in block 155 (blocks 160 and 165).

Those skilled in the art will appreciate that in the simplest case of a 4×4 prediction block, linear interpolation will not be required so that interpolation need not be performed.

If the decision is to apply both vertical and horizontal linear interpolation, the encoder/decoder 24, 44 needs to determine the order in which vertical and horizontal interpolation are performed. The decision of which direction to apply first is made based on the width W and height H of the current block. If the decision is to first apply vertical linear interpolation, the encoder/decoder 24, 44 determines the size of the reduced top boundary bdry_{redll}^{top} for the vertical linear interpolation by the width W and the height H of the current block and derives the reduced top boundary bdry_{redll}^{top} from the original top boundary samples. If the decision is to first apply horizontal linear interpolation, the encoder/decoder 24, 44 determines the size of the reduced left boundary bdry_{redll}^{left} for the horizontal linear interpolation by the width W and the height H of the current block and derive the reduced left boundary bdry_{redll}^{left} from the original left boundary samples.

The method of intra predication as shown in FIG. 10 can be performed by the encoder 24 or decoder 44. In an encoder 24, the prediction block 24 is subtracted from the current block to derive the residual as shown in FIG. 2. The residual is then encoded for transmission to the destination device 40. In a decoder 44, the prediction block 24 is calculated and added to the decoded residual received from the source device 20 as shown in FIG. 3 in obtain the output video.

Some embodiments of the disclosure reduce complexity of the MIP by using a simplified downsampling approach to derive the intermediate reduced boundary samples without averaging. Given a W×H block, when both the horizontal and vertical linear interpolation are applied to the current block, the encoder/decoder 24, 44 determines the order in which vertical linear interpolation horizontal linear interpolation are performed. If H≤W, the vertical linear interpolation is applied first to the reduced prediction signal pred_{red}. The reduced top boundary bdry_{redll}^{top} samples for the vertical linear interpolation are derived by taking every K-th sample of the original top boundary samples without average operation. If H>W, the horizontal linear interpolation is applied first to the reduced prediction signal pred_{red}. The reduced left boundary bdry_{redll}^{left} samples for the horizontal linear interpolation are derived by taking every K-th sample of the original left boundary samples without average operation.

The number K is a down-sampling factor which is determined by the width W and height H of the current block. The value of K can be equal to 2, 4 or 8. For example, the value K can be selected according to the following rules:
If H≤W and W=8, K=2.
If H≤W and W>8, K=W/8, where W=16, 32 or 64.
If H>W, K=H/8, where H=16, 32 or 64.

The reduced boundary bdry_{redll} samples derivation process is as follows. A position (xCb, yCb) specifies the position of the top-left sample the current coding block of the current picture. The positions of the top boundary samples are (xT, yT), where xT=xCb . . . xCb+W 1, yT=yCb 1. The positions of the left boundary samples are (xL, yL), where xL=xCb 1, yL=yCb . . . yCb+H 1. The dimension of the reduced prediction signal is predW×predH. The values of predW and predH can be determined as follows:
If W≤8 and H≤8, predW=predH=4.
If W>8 and H=4, predW=8, predH=4.
If W=4 and H>8, predW=4, predH=8.
Otherwise, predW=8, predH=8.

If the decision is to first apply the vertical linear interpolation, the downsampling factor K is derived as equal to (W/predW). The reduced top boundary bdry_{redll}^{top} samples are derived from every K-th sample of the original top boundary samples. The position (x, y) for the K-th sample of the original top boundary samples is specified as:
x=xCb+n×K−1, where n ranges from 1 to predW.
y=yCb−1.

If the decision is to first apply the horizontal linear interpolation, the downsampling factor K is derived as equal to (H/predH). The reduced left boundary bdry_{redll}^{left} samples are derived from every K-th sample of the original left boundary samples. The position (x, y) for the K-th sample of the original left boundary samples is specified as:
x=xCb 1.
y=yCb+n×K 1, where n ranges from 1 to predH.

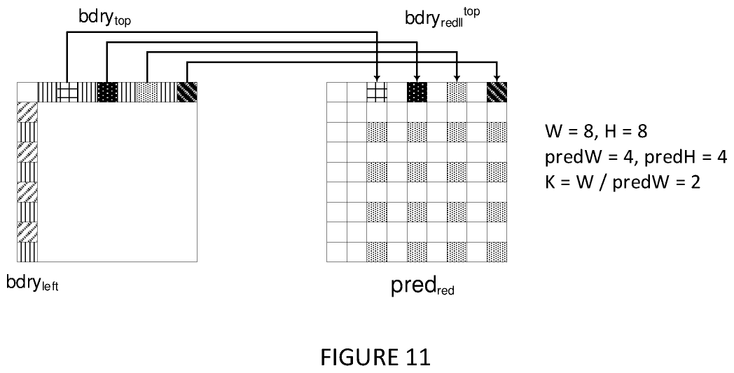

FIG. 11 shows an exemplary downsampling method used to derive the interpolation boundary samples for vertical linear interpolation without averaging. Given a W×H block, where W=8 and H=8, the vertical linear interpolation is first applied to the reduced prediction signal pred_{red}. The dimension of the reduced prediction signal is predW×predH, where, predW=4 and predH=4. The 4 reduced top boundary bdry_{redll}^{top} samples for the vertical linear interpolation are derived by taking every 2-nd of the original top boundary samples as shown in FIG. 11:

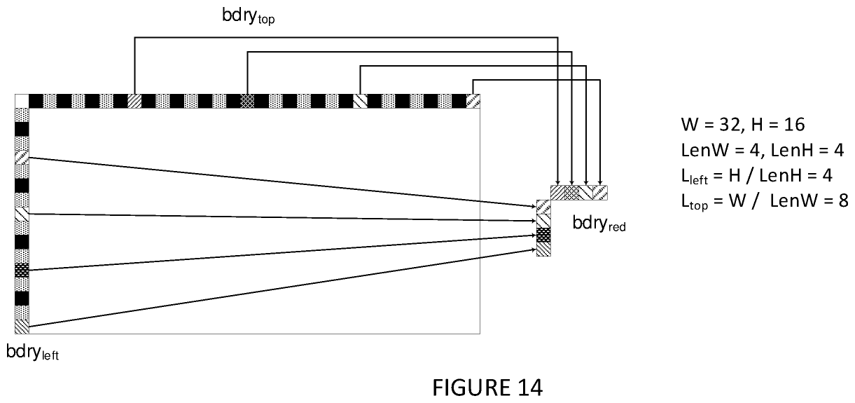

Given a W×H block, where W≥16 and H 16. If H≤W, the vertical linear interpolation is applied first to the reduced prediction signal pred_{red}. The dimension of the reduced prediction signal is predW×predH, where, predW=8 and predH=8. The 8 reduced top boundary bdry_{redll}^{top} samples for the vertical linear interpolation are derived from every K-th (K=W/8) of the original top boundary samples. If H>W, the horizontal linear interpolation is first applied to the reduced prediction signal. The dimension of the reduced prediction signal is predW×predH, where, predW=8 and predH=8. The 8 reduced left boundary bdry_{redll}^{left} samples for the horizontal linear interpolation are derived from every K-th (K=H/8) of the original left boundary samples. FIG. 14 shows an example of reduced left boundary for a 16×32 block.

Some embodiments of the disclosure use a simplified downsampling approach to derive the reduced boundary samples for matrix multiplication. Given a W×H block, when the current block is a matrix based intra predicted block, the reduced boundary bdry_{red} is used for matrix multiplication. The bdry_{red} samples are derived from every L-th sample of the original boundary samples without average operation. The number L is a down-sampling factor which is determined by the width W and height H of the current block. The number L for the left and top boundary is further specified as Lleft and Ltop respectively, where:
L_{left}=Lₜₒₚ, when W equals to H
L_{left}≠Lₜₒₚ, where W≠H
   The value of L can be equal to 1, 2, 4, 8 or 16. For example, the value of L can be selected according to the following rules:
If W=4 and H=4, L_{left}=Lₜₒₚ=2.
If W>4 or H>4,
   L_{left}=H/4 when H=4, 8, 16, 32 or 64.
   Lₜₒₚ=W/4 when W=4, 8, 16, 32 or 64.

The reduced boundary bdry_{red} samples derivation process is as follows. A position (xCb, yCb) specifies the position of the top-left sample the current coding block of the current picture. The position for top boundary samples are (xT, yT), where xT=xCb . . . xCb+W−1, yT=yCb−1. The position for left boundary samples are (xL, yL), where xL=xCb−1, yL=yCb . . . yCb+H−1. The size of the reduced boundary bdry_{red} is LenW+LenH, where LenW specifies the number of reduced boundary samples from the original top boundary, LenH specifies the number of reduced boundary samples from the left boundary. In the current version of VVC, LenW and LenH are determined as follows:
If W=H=4, LenW=LenH=2.
If W>4 or H>4, LenW=LenH=4.

The downsampling factor Ltop is derived as equal to (W/LenW). The reduced top boundary bdry_{red}^{top} samples are derived from every Lₜₒₚ-th sample of the original top boundary samples. The position (x, y) for the Lₜₒₚ-th sample of the original top boundary samples is specified as:
x=xCb+n×Lₜₒₚ−1, where n ranges from 1 to LenW.
y=yCb−1.

The downsampling factor L_{left} is derived as equal to (H/LenH). The reduced left boundary bdry_{red}^{left} samples are derived from every L_{left}-th sample of the original left boundary samples. The position (x, y) for the L_{left}-th sample of the original left boundary samples is specified as:
x=xCb−1.
y=yCb+n×L_{left}−1, where n ranges from 1 to LenH.

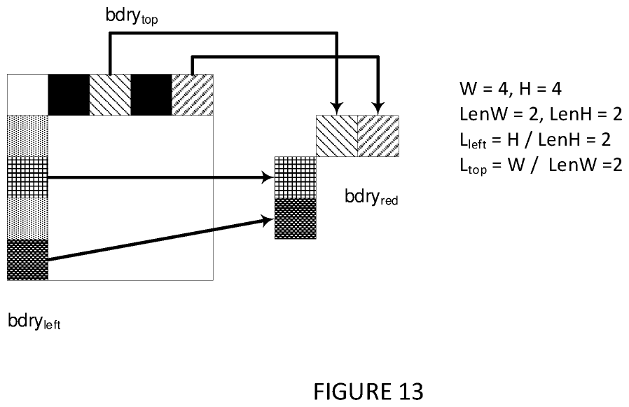

FIG. 13 shows an exemplary downsampling method used to derive the reduced boundary samples for input to the MMU for a W×H block, where W=4 and H=4. In this example, the size of the reduced boundary bdry_{red} is LenW+LenH, where, LenW=2 and LenH=2. The reduced boundary bdry_{red} samples are derived from every 2-nd sample of the original top boundary samples and every 2-nd sample of the original left boundary.

FIG. 14 shows an exemplary downsampling method used to derive the reduced boundary samples for input to the MMU for a W×H block, where W=32 and H=16. In this example, the size the reduced boundary bdry_{red} is LenW+LenH, where, LenW=4 and LenH=4. The reduced boundary samples are derived from every 8-th sample of the original top boundary samples and every 4-th sample of the original left boundary.

Given a W×H block, the decision whether or not to apply the method to derive the reduced boundary bdry_{red} for matrix multiplication from every L-th sample of the original boundary samples without average operation is determined by the size of bdry_{red}^{left} and bdryᵣₑₚ^{top} and the dimension predW×predH of the reduced predicted signal pred_{red}.

In this embodiment, when the size of bdry_{red}^{left}=predH, the matrix multiplication does not carry out vertical upsampling. Instead, the samples of bdry_{red}^{left} are derived from every L_{left}-th sample of the original left boundary samples without average operation. In the current version of VVC, when the current block is a W×4 block, where W>4, the size of bdry_{red}^{left} equals to predH. Therefore, the samples of bdry_{red}^{left} are in this embodiment derived from the original left boundary samples without average, where L_{left}=1. One example of an 8×4 block is shown in FIG. 5.

In this embodiment, when the size of bdry_{red}^{top}=predW, the matrix multiplication does not carry out a horizontal up-sampling. Instead, the samples of bdry_{red}^{top} are derived from every Lₜₒₚ-th sample of the original top boundary samples without average operation. In the current version of VVC, when the current block is a 4×H block, where H>4, the size of bdry_{red}^{top} equals to predW. Therefore, the samples of bdry_{red}^{top} are in this embodiment derived from the original top boundary samples without average, where Lₜₒₚ=1.

Some embodiments of the disclosure use a simplified downsampling approach that reduces the computational complexity involved in computing averages of boundary samples. Given a W×H block, when the current block is matrix based intra predicted block, the reduced boundary bdry_{red} is used for matrix multiplication. The bdry_{red} samples are derived by averaging N (where N>1) samples from every M-th sample of the original boundary samples.

The number N is the matrix multiplication up-sampling factor which is determined by the dimension (predW×predH) of the reduced predicted signal pred_{red} and the size (LenW+LenH) of the reduced boundary bdry_{red}, where, predW, predH, LenW and LenH are determined by the width W and height H of the current block. The number N for the left and top boundary is further specified as N_{left} and Nₜₒₚ, where:
If predH>LenH, the matrix multiplication carries out a vertical up-sampling, in this case, N_{left}=predH/lenH
If predW>LenW, the matrix multiplication carries out a horizontal up-sampling, in this case, Nₜₒₚ=predW/lenW

In the current version of VVC, when the matrix multiplication carries out up-sampling, the supported up-sampling factor N is 2.

The number M is a down-sampling factor which is determined by the width W and height H of the current block. The number M for the left and top boundary is further specified as M_{left} and Mₜₒₚ respectively, where:
M_{left}=Mₜₒₚ, where W equals to H
M_{left}≠Mₜₒₚ, where W≠H

The value of M can be 1, 2, 4 or 8. For example, the value M can be selected according to the following rules:
If W=4 and H=4, M_{left}=Mtop=1.
If W≥4 and M_{left}=H/predH, where H=8, 16, 32 or 64, predH=8.
If W>8 and H>4, Mₜₒₚ=W/predW, where W=8, 16, 32 or 64, predW=8

The reduced boundary bdry_{red} samples derivation process is as follows. A position (xCb, yCb) specifies the position of the top-left sample the current coding block of the current picture. The position for top boundary samples are (xT, yT), where xT=xCb . . . xCb+W−1, yT=yCb−1. The position for left boundary samples are (xL, yL), where xL=xCb−1, yL=yCb . . . yCb+H−1. The size of the reduced boundary bdry_{red} is LenW+LenH, where LenW specifies the number of reduced boundary samples from the original top boundary, LenH specifies the number of reduced boundary samples from the left boundary. The dimension of the reduced prediction signal pred_{red} is predW×predH, where predW specifies the width sample of the pred_{red}, predH specifies the height of the pred_{red}. The values of LenW, LenH, predW and predH can be determined as follows:
If W=H=4, LenW=LenH=2, predW=predH=4.
Otherwise, if W≤8 and H≤8, LenW=LenH=4, predW=predH=4.
Otherwise, if W=4 and H>8, LenW=LenH=4, predW=4, predH=8.
Otherwise, if W>8 and H=4, LenW=LenH=4, predW=8, predH=4.
Otherwise, LenW=LenH=4, predW=predH=8.

The downsampling factor Mₜₒₚ is derived as equal to (W/predW). The reduced top boundary bdry_{red}^{top} samples are derived by averaging two samples (x₀, y₀) and (x₁, y₁) from every Mₜₒₚ-th sample of the original top boundary samples. The positions (x₀, y₀) and (x₁, y₁) for the Mₜₒₚ-th sample of the original top boundary samples are specified as:
x0=xCb+(2×n 1)×Mₜₒₚ−1
x1=xCb+(2×n)×Mₜₒₚ−1, where n ranges from 1 to LenW.
y0=y1=yCb 1.

The down-sampling factor M_{left} is derived as equal to (H/predH). The reduced left boundary bdry_{red}^{left} samples are derived by averaging two samples (x₀, y₀) and (x₁, y₁) from every M_{left}-th sample of the original left boundary samples. The positions (x₀, y₀) and (x₁, y₁) for the L_{left}-th sample of the original left boundary samples are specified as:
x0=x1=xCb−1.
y0=yCb+(2×n−1)×M_{left}−1
y0=yCb+(2×n)×M_{left}−1, where n ranges from 1 to LenH.

Given a W×H block, where W=4 and H=4, the size the reduced boundary bdry_{red} is LenW+LenH, where, LenW=2 and LenH=2. The reduced boundary bdry_{red} samples are derived the same as the current version of VVC as shown in FIG. 4.

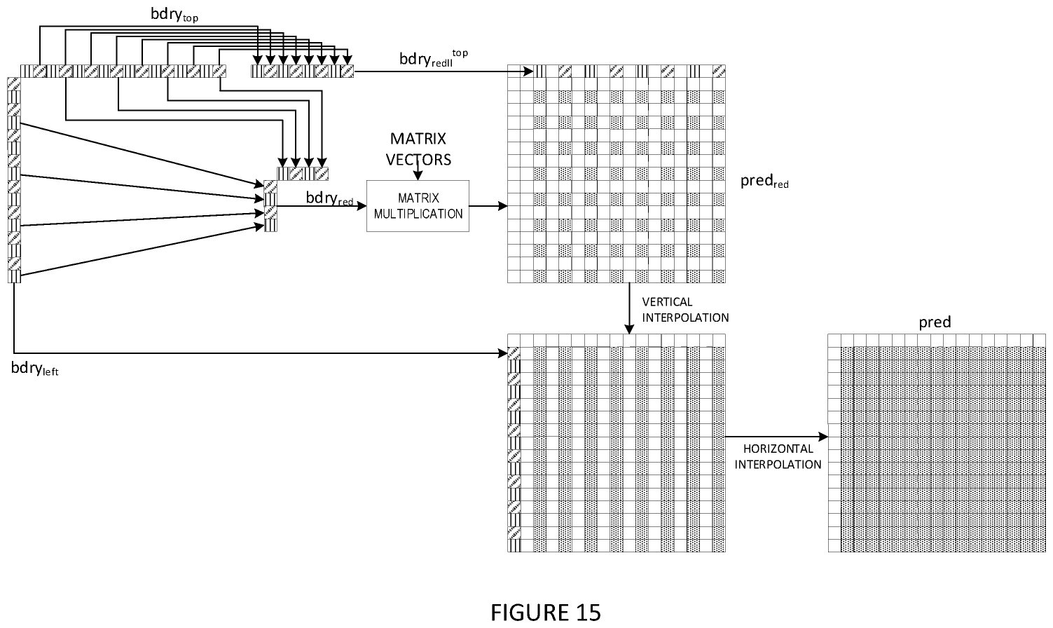

FIG. 15 shows an exemplary downsampling method used to derive the reduced boundary samples for input to the MMU for a W×H block, where W=32 and H=16. The size the reduced boundary bdry_{red} is LenW+LenH, where, LenW=4 and LenH=4. The dimension of the reduced prediction signal is predW×predH, where predW=8 and predH=8. The reduced boundary bdry_{red} samples are derived by averaging 2 samples from every 4-th sample of the original top boundary samples and every 2-nd of the original left boundary as shown in FIG. 15.

The downsampling techniques as herein described, in addition to reducing computational complexity, provide a useful technique for aligning the reduced boundary samples used for matrix multiplication and linear interpolation with the output of the MMU. In some embodiments, at least one sample is derived from horizontal boundary for MMU input with a filter which is centered in-between two MMU output samples horizontally when MMU output is sparse in the horizontal direction and with a filter which is centered in-between two MMU output samples vertically when MMU output is sparse in the vertical direction. One example of a filter which is centered in-between two MMU output samples in one direction is [1 0 1]/2 when MMU output comes every second sample ‘x’ MMUOut(1) ‘x’ MMUOut(2). This gives a MMU input which is centered in-between MMUOut(1) and MMUOut(2). This can be implemented as (‘a’+‘b’+1)>>1 where ‘a’ is aligned with MMUOut(1) and ‘b’ is aligned with MMUOut(2). Another example is [1 2 1]/4 which can be implemented as ‘(a’+2*‘c’+‘b)>>2 where ‘a’ is aligned with MMUOut(1) and ‘b’ is aligned with MMUOut(2) and ‘c’ is aligned with a sample in-between MMUOut(1) and MMUOut(2).

A similar technique can be used to derive the reduced boundary samples for interpolation. Thus, in some embodiments, at least one sample is derived from horizontal boundary samples which is aligned with at least one MMU output sample horizontally and use the derived sample for interpolation of a sample in-between the MMU output sample and the derived sample in the vertical direction or derive at least one sample from vertical boundary samples which is aligned with at least one MMU output sample vertically and use that sample for interpolation of a sample in-between the MMU output sample and the derived sample in the horizontal direction. One example is to use a filter of size N=1 to derive a boundary sample. This corresponds to copy the boundary samples that are aligned with the MMU output in the horizontal direction when interpolation samples in the vertical direction and copy boundary samples that are aligned with the MMU output in the vertical direction when interpolating samples in the horizontal direction. Another example is to use a filter of size N=3 with filter coefficients [1 2 1]/4 to generate an aligned boundary sample. This can be implemented as ‘(a’+2*‘c’+‘b)>>2, where ‘c’ is a boundary sample aligned with the MMU output sample that is to be used for interpolation and ‘a’ and ‘b’ are neighboring boundary samples at equal distance from the boundary sample c.

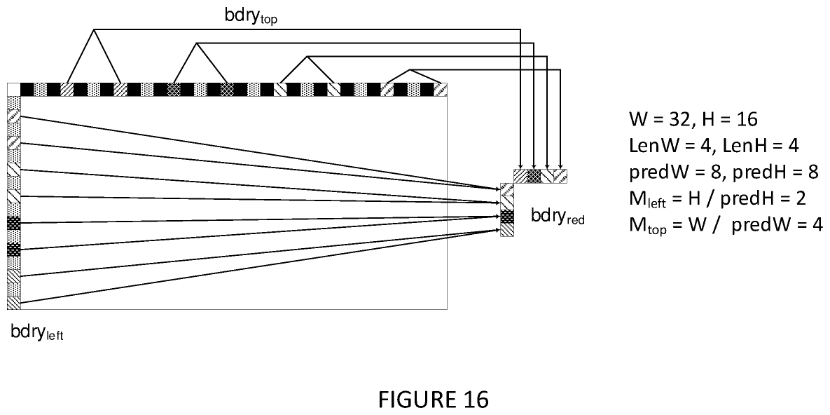

The methods described above to derive the reduced boundary samples for matrix multiplication and linear interpolation can be used independently or in combination. FIG. 16 shows an example where simplified downsampling without averaging is used for deriving the reduced boundary samples for both liner interpolation and matrix multiplication. In this example, the current block has dimension W×H where W=H=16. The intermediate reduced boundary bdry_{redll} has dimensions 8×8 and the reduced boundary bdry_{red} has dimensions 4×4. The boundary samples for bdry_{redll}^{top and} bdry_{red}^{top} are derived at the same time in parallel from the original boundary samples bdry^{top} without averaging. In other embodiments, averaging could be used to derive the intermediate reduced boundary bdry_{redll}, the reduced boundary bdry_{red}, or both

As noted earlier, the two-step derivation process for the reduced boundary bdry_{red} when linear interpolation is performed increases the latency of the encoder 24 and decoder 44. As an example, assume that it is desirable to process a 16×16 block and that the first samples of bdrytop are:
bdry^{top}=510, 511, 510, 510, . . .

In the prior art, the first two samples 510 and 511 would be averaged using addition and shift: (510+511+1)>>1=1022>>1=511, where >> denotes rightwards arithmetic shift. Likewise the next two samples 510 510 would be averaged to (510+510+1)>>1=1021>>1=510. Hence the first two samples of bdry_{redll}^{top} would become:
bdry_{redll}^{top}=511, 510, . . .

The first two samples of bdry_{redll}^{top} are then used to calculate bdry_{red}^{top} using (511+510+1)>>1=1022>>1=511. Hence the first sample in bdry_{red}^{top} would become
bdry_{red}^{top}=511, . . .

Now, due to latency, it is desirable to calculate bdry_{red}^{top} in one step. However, a straight-forward implementation would be to add the four first number in bdry^{top} together with the constant two for rounding and then shift two steps:
one_step_bdry_{red}^{top}=(510+511+510+510+2)>>2=2043>>2=510

However, the result of this calculation, one_step_bdry_{red}^{top}=510, does not give the same result as the two step approach of calculating bdry_{red}^{top}=511 described above. This error will lead to drift in the decoder, which is not desirable.

Hence, in one embodiment of the present disclosure, bdry_{red}^{top} is calculated in according to:
alt_one_step_bdryredtop=(510+511+510+510+3)>>2=2044>>2=511.

This approach reduces the latency compared to first calculating aa=(a+b+1)>>1 and bb=(b+c+1)>>1 followed by a second step aaa=(aa+bb+1)>>1.

The difference in this approach is that the sum is calculated by adding 3 instead of adding two to yield the same behavior as the two-step approach. The equivalency of the one-step approach can be demonstrated with a simple example. Assume that the first four boundary samples in bdry^{top} are denoted a, b, c and d respectively, and that the first two boundary samples in bdry_{redll}^{top} are denoted aa and bb respectively. In this example, aa=(a+b+1)>>1 and bb=(c+d+1)>>1. The first sample in bdry_{red}^{top}, denoted aaa, is calculated as (aa+bb+1)>>2. As shown in Table 1 below, adding value 2 to the sum of a, b, c, and d ((a+b+c+d+2)>>2) produces an error when only one of the values of a, b, c and d equals 1 and the others equal 0, while adding 3 (a+b+c+d+3)>>2 produces the correct result.

TABLE 1
Comparison of Averaging Approaches

| | | | | | | | (a + b + c + d + | (a + b + c + d + |
|---|---|---|---|---|---|---|---|---|
| a | b | c | d | aa | bb | aaa | 2) >> 2 | 3) >> 2 |
| 0 | 0 | 0 | 0 | 0 | 0 | 0 | 0 | 0 |
| 0 | 0 | 0 | 1 | 0 | 1 | 1 | 0 | 1 |
| 0 | 0 | 1 | 0 | 0 | 1 | 1 | 0 | 1 |
| 0 | 0 | 1 | 1 | 0 | 1 | 1 | 1 | 1 |
| 0 | 1 | 0 | 0 | 1 | 0 | 1 | 0 | 1 |
| 0 | 1 | 0 | 1 | 1 | 1 | 1 | 1 | 1 |
| 0 | 1 | 1 | 0 | 1 | 1 | 1 | 1 | 1 |
| 0 | 1 | 1 | 1 | 1 | 1 | 1 | 1 | 1 |
| 1 | 0 | 0 | 0 | 1 | 0 | 1 | 0 | 1 |
| 1 | 0 | 0 | 1 | 1 | 1 | 1 | 1 | 1 |
| 1 | 0 | 1 | 0 | 1 | 1 | 1 | 1 | 1 |
| 1 | 0 | 1 | 1 | 1 | 1 | 1 | 1 | 1 |
| 1 | 1 | 0 | 0 | 1 | 0 | 1 | 1 | 1 |
| 1 | 1 | 0 | 1 | 1 | 1 | 1 | 1 | 1 |
| 1 | 1 | 1 | 0 | 1 | 1 | 1 | 1 | 1 |
| 1 | 1 | 1 | 1 | 1 | 1 | 1 | 1 | 1 |

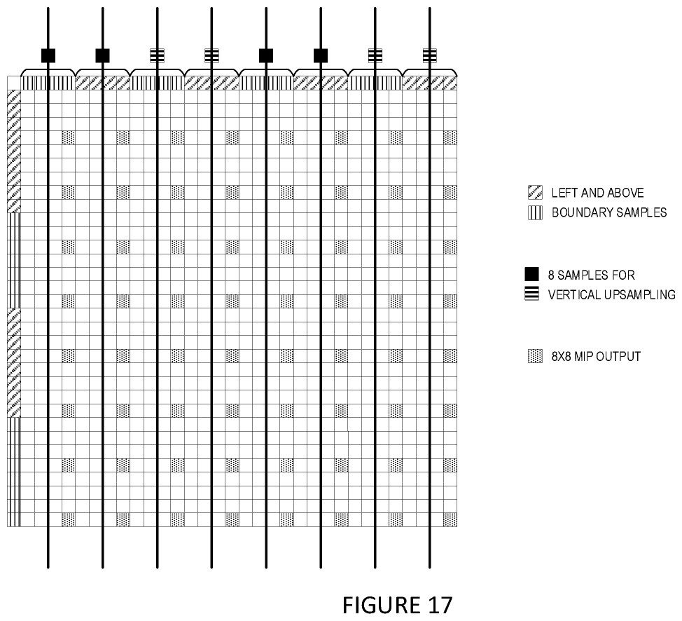

In one embodiment, the misalignment between boundary samples used for interpolation and the MMU output is solved in a different way. Instead of just taking a single sample, averaging is performed. However, by changing which samples goes into the averaging, it is possible to reduce or eliminate the misalignment. As shown in the FIG. 17, the previous art uses four tap filters to obtain one sample for vertical upsampling. As can be seen in FIG. 17, there is a strong misalignment between the center of the averaged samples (shown as lines) and the pixels used for MMU output (“MIP output”). In this example, the misalignment can be reduced by selecting different samples for the averaging. By shifting the boundary samples selected for averaging one step to the right, the misalignment between the center of the averaged samples (the lines) and the MMU output samples (shaded as “MIP output” pixels) is reduced to one half the width of a boundary sample. However, at the last sample, four samples can no longer be used. Therefore, in one embodiment, averaging occurs only over two samples here. An alternative is to use the previous averaging arrangement for this last position, which will result in larger misalignment for this sample. Further downsampling details may are provided in Application Ser. No. 62/861,546, which is incorporated herein by reference.

In all of the above-discussed MIP techniques, the matrix multiplication has the potential to create out-of-bound prediction samples in the prediction block output by the prediction unit 28, 54. For example, any prediction sample having a value less than zero (i.e., a negative value) or greater than a predetermined maximum value, e.g., 2^{bitDepth}−1, would be considered out of range. To address this issue, clipping may be applied to the prediction block, e.g., all negative values are set to zero and all prediction samples having a value greater than the maximum value are set to the maximum value. Such clipping operations, however, may introduce extensive latency, especially for larger prediction blocks. The solution presented herein reduces this latency by clipping the prediction samples in the reduced prediction matrix output by the matrix multiplication unit.

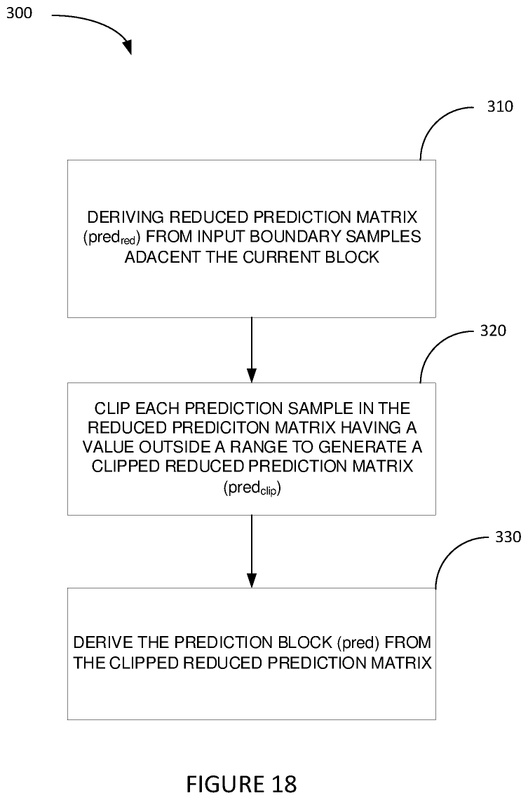

FIG. 18 shows an exemplary method 300 of MIP implemented by an encoder 24 or decoder 44. The prediction unit 28, 54 derives a reduced prediction matrix from input boundary samples adjacent the current block (block 310), where the reduced prediction matrix has a number of prediction samples less than the size of the prediction block. The prediction unit 28, 54 then clips each prediction sample in the reduced prediction matrix having a value outside the range to generate a clipped reduced prediction matrix (block 320), and derives the prediction block from the clipped reduced prediction matrix (block 330). In so doing, the solution presented herein reduces the number of clipping operations without sacrificing quality, and thus reduces latency associated with the operations of the prediction unit 28, 54.

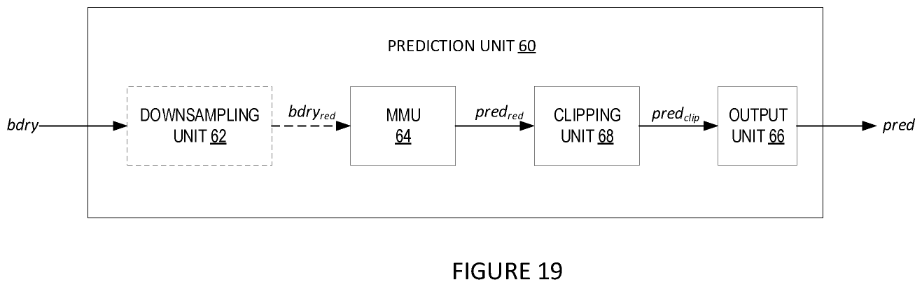

FIG. 19 shows an exemplary MIP unit 60, which can be used as the prediction unit 28, 54 in the encoder 24 or decoder 44 respectively. The MIP unit 60 comprises an optional downsampling unit 62, MMU 64, clipping unit 68, and output unit 66. The MMU 64, clipping unit 68, and output unit 66 are referred to herein collectively as the block prediction unit 69. The prediction unit 68 derives the prediction block from the input boundary samples. When used, the downsampling unit 62 is configured to downsample the input boundary samples to derive reduced boundary samples used for matrix multiplication, e.g., according to any of the downsampling techniques discussed herein. The MMU 64 is configured to multiply the reduced boundary bdry_{red} by matrix vectors to derive a reduced prediction block pred_{red}. The clipping unit 64 clips any prediction samples in pred_{red} outside the range to generate a clipped reduced prediction matrix p_{clip}. The output unit 66 derives the prediction block pred from the clipped reduced prediction block. For example, the output unit 66 may comprise an interpolation unit 66 configured to perform linear interpolation on the clipped prediction samples in the clipped reduced prediction block (and possibly using the input boundary values) to derive the remaining predication samples in pred.

The following provides additional explanation and details regard the clipping solution presented herein. The reduced prediction signal pred_{red} is derived by matrix multiplication of reduced boundary samples bdry_{red} and the matrix vector. The pred_{red} could have one or several samples with a value out of the sample value range.
The pred_{red} could have one or several samples with negative values.
The pred_{red} could have one or several samples with values that are larger than 2^{bitDepth}−1, where bitDepth specifies the bit depth of the current color component.

The prediction signal pred at the remaining positions of the current block that is generated from the pred_{red} by linear interpolation could have one or several samples with a value out of the sample value range.

Given a W×H block that is predicted by MIP, the sample value clip operation is applied to all samples of the predicted signal predSamples[x][y], where x=0 . . . W−1 and y=0 . . . H−1.
predSamples[x][y]=Clip1_{Y}(predSamples[x][y]), where,
   predSamples[x][y]=0, when predSamples[x][y]<0
   predSamples[x][y]=predSamples[x][y], when 0 s predSamples[x][y] s 2^{bitDepth}−1
   predSamples[x][y]=2^{bitDepth}−1, when predSamples[x][y]>2^{bitDepth}−1

The sample value clipping operation needs two compares operations and one value assignment operation. The sample value clipping operation increases both software and hardware complexity.

The last step of the current design of the MIP process is the sample value clipping operation on all prediction samples. In current VVC configuration, the maximum intra block size is 64×64. For a MIP predicted block, the worst case is therefore to apply sample value clipping operations on 4096 samples.

The main advantage is to reduce the complexity of matrix based intra prediction both for the encoder and the decoder. This is done by reducing the number of sample value clipping operations.

An example in the VVC reference code, VTM, has been implemented. The number of the sample value clipping operations for a MIP predicted block is reduced as shown in Table 2:

TABLE 2
Number of Sample Value Clipping Operations for the
Proposed Solution as Compared to Previous Solutions

| Block dimension W × H | Current VTM | Proposed |
|---|---|---|
| 4 × 4 | 16 | 16 |
| 4 × 8 or 8 × 4 | 32 | 16 |
| 4 × 16 or 16 × 4 | 64 | 32 |
| 4 × 32 or 32 × 4 | 128 | 32 |
| 4 × 64 or 64 × 4 | 256 | 32 |
| 8 × 8 | 64 | 16 |
| 8 × 16 or 16 × 8 | 128 | 64 |
| 8 × 32 or 32 × 8 | 256 | 64 |
| 8 × 64 or 64 × 8 | 512 | 64 |
| 16 × 16 | 256 | 64 |
| 16 × 32 or 32 × 16 | 512 | 64 |
| 16 × 64 or 64 × 16 | 1024 | 64 |
| 32 × 32 | 1024 | 64 |
| 32 × 64 or 64 × 32 | 2048 | 64 |
| 64 × 64 | 4096 | 64 |

The proposed method has negligible coding efficiency impact compared to VTM5.0. The BD-rate result is as follows:

| All Intra Main10 | | | | |
|---|---|---|---|---|
| Over VTM-5.0rc1 (host timing MD5) | | | | |
| Y | U | V | EncT | DecT |

| | | | |
|---|---|---|---|
| Class A1 | 0.00% | 0.03% | 0.02% |
| Class A2 | 0.00% | 0.01% | 0.00% |
| Class B | 0.00% | 0.02% | 0.03% |
| Class C | 0.00% | 0.02% | 0.04% |
| Class E | 0.00% | 0.01% | 0.04% |
| Overall | 0.00% | 0.01% | 0.00% |
| Class D | 0.00% | 0.02% | 0.01% |
| Class F | | | |

| | Random Access Main10 | | | | |
|---|---|---|---|---|---|
| | Over VTM-5.0rc1 (host timing MD5) | | | | |
| | Y | U | V | EncT | DecT |
| Class A1 | 0.00% | −0.09% | −0.02% | | |
| Class A2 | 0.00% | 0.02% | 0.02% | | |
| Class B | 0.00% | −0.04% | 0.05% | | |
| Class C | −0.02% | −0.09% | 0.00% | | |
| Class E | | | | | |
| Overall | 0.00% | −0.05% | 0.01% | | |
| Class D | 0.01% | 0.05% | 0.05% | | |
| Class F | | | | | |

| | Low Delay B Main10 | | | | |
|---|---|---|---|---|---|
| | Over VTM-5.0rc1 (host timing MD5) | | | | |
| | Y | U | V | EncT | DecT |
| Class A1 | | | | | |
| Class A2 | | | | | |
| Class B | −0.01% | 0.05% | 0.59% | | |
| Class C | −0.02% | 0.04% | −0.11% | | |
| Class E | −0.08% | −0.56% | −0.15% | | |
| Overall | −0.03% | −0.10% | 0.17% | | |
| Class D | 0.05% | 0.05% | 0.27% | | |
| Class F | | | | | |

The following provides a detailed example of the clipping solution presented herein. The proposed solution consists of a method for video encoding or decoding for a current intra predicted block.

The method can be applied for a block which is coded using a matrix based intra prediction (MIP) coding mode.

The method can be applied in an encoder and/or decoder of a video or image coding system. In other words, a decoder may execute the method described here by all or a subset of the following steps to decode an intra predicted block in a picture from a bitstreams:
1. Derive the size of the current CU as a width value W and height value H by decoding syntax elements in the bitstream.
2. Determine that the current block is an Intra predicted block from decoding elements in the bitstream.
3. Determine that the current block is a matrix based intra prediction block from decoding elements in the bitstream.
4. Determine a prediction mode for the current block from decoding elements in the bitstream.
5. Derive a mipSizeId value from the width W and the height H.
6. Determine a matrix vector to use for the current block from a matrix vector look-up table by using the prediction mode and the mipSizeId value as table index.
7. Determine the original boundary sample values for the current block. The original boundary samples are W samples from the nearest neighbouring samples to the above of the current block and H samples from the nearest neighbouring samples to the left of the current block.
8. Determine the size of the reduced boundary bdry_{red} by the mipSizeId value of the current block.
9. Determine the dimension size of the reduced prediction signal pred_{red} by the mipSizeId value of the current block.
10. Derive the reduced boundary bdry_{red} from the original boundary samples.
11. Derive the reduced prediction signal pred_{red}^{temp} by matrix multiplication of the matrix vector and the reduced boundary bdry_{red}.
12. Derive the reduced prediction signal pred_{red} by using sample value clipping on each sample of the pred_{red}^{temp}.
13. Determine whether or not to apply vertical linear interpolation to the reduced prediction signal pred_{red} by the width W and the height H of the current block.
14. Determine whether or not to apply horizontal linear interpolation to the reduced prediction signal pred_{red} by the width W and the height H of the current block.
15. If the decision is to apply both vertical and horizontal linear interpolation,
   a. determine which linear interpolation direction to apply firstly by the width W and the height H of the current block.
   b. If the decision is to first apply vertical linear interpolation,
      i. Determine the size of the reduced top boundary bdry_{redll}^{top} for the vertical linear interpolation by the width W and the height H of the current block.
      ii. Derive the reduced top boundary bdry_{redll}^{top} from the original top boundary samples.
   c. If the decision is to first apply horizontal linear interpolation,
      i. Determine the size of the reduced left boundary bdry_{redll}^{left} for the horizontal linear interpolation by the width W and the height H of the current block.
      ii. Derive the reduced left boundary bdry_{redll}^{left} from the original left boundary samples.
16. Derive the MIP prediction block pred by generating the sample values at the remaining positions by using linear interpolation.
17. Decode the current block by using the derived MIP prediction block.

For example, the sample value clipping operation is applied on the reduced prediction signal before using linear interpolation to derive the samples at the remaining positions of MIP prediction block. Since the input sample values to the linear interpolation range from 0 to 2^{bitDepth}−1, the output sample values also range from 0 to 2^{bitDepth}−1. Therefore it is not necessary to apply sample value clipping operation on the samples at the remaining positions of MIP prediction block that are derived by linear interpolation.

Given two samples p[0] and p[2^{N}], where N≥1, the samples p[x] between p[0] and p[2^{N}] are derived by linear interpolation as follows:
p[x]=(x*p[0]+(k−x)*p[2^{N}]+2^{N}−1)>>N, where x=1 . . . (2^{N}−1)
   The derived p[x]≥minimum (p[0], p[2^{N}])≥0
   The derived p[x]≤maximum (p[0], p[2^{N}])≤2^{bitDepth}−1

Clipping can be omitted for any filter which is used to interpolate samples from the MIP output samples to remaining samples of the prediction block as long as the filter coefficients sums to unity (e.g., 1 or a multiple of 2 which corresponds to 1 in fixed point arithmetic) and that none of the filter coefficient values is negative.

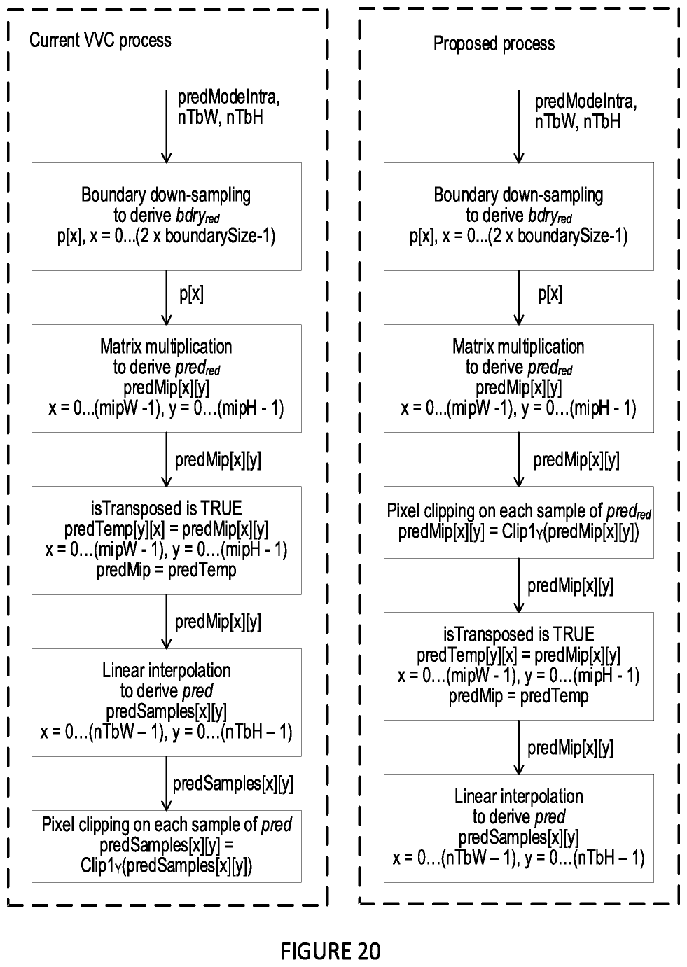

The following shows specification draft text on top of the current VVC specification, where FIG. 20 shows the difference of MIP intra sample prediction process between the current VVC design and the proposed design.

For the intra sample prediction process according to predModeIntra, the following “draft text” ordered steps apply:
1. The matrix-based intra prediction samples predMip[x][y], with x=0 . . . mipW−1, y=0 . . . mipH−1 are derived as follows:
   a. The variable modeId is derived as follows:

modeId=predModeIntra−(isTransposed ? numModes/2:0) (8-63)
b. The weight matrix mWeight[x][y] with x=0 . . . 2*boundarySize−1, y=0 . . . predC*predC−1 is derived using MipSizeId[xTbCmp][yTbCmp] and modeId as specified in Table 8-8
c. The bias vector vBias[y] with y=0 . . . predC*predC−1 is derived using sizeId and modeId as specified in Table 8-8.
d. The variable sW is derived using MipSizeId[xTbCmp][yTbCmp] and modeId as specified in Table 8-8.
e. The matrix-based intra prediction samples predMip[x][y], with x=0 . . . mipW−1, y=0 . . . mipH−1 are derived as follows:

oW=1<<(sW−1) (8-64)

sB=BitDepthy−1 (8-65)

incW=(predC>mipW) ? 2:1 (8-66)

incH=(predC>mipH) ? 2:1 (8-67)

predMip[x][y]=((Σᵢ₌₀^{2*boundarySize-1}mWeight[i][y*incH*predC+x*incW]*p[i])+(vBias[y*incH*predC+x*incW]<<sB)+oW)>>sW (8-68)
2. When isTransposed is equal to TRUE, the predH×predW array predMip[x][y] with x=0 . . . predH−1, y=0 . . . predW−1 is transposed as follows:

predTemp[y][x]=predMip[x][y] (8-69)

predMip=predTemp (8-70)
3. The predicted samples predSamples[x][y], with x=0 . . . nTbW−1, y=0 . . . nTbH−1 are derived as follows:
   If needUpsBdryVer is equal to TRUE or needUpsBdryHor is equal to TRUE, the MIP prediction upsampling process as specified in clause 8.4.5.2.4 is invoked with the input block width predW, the input block height predH, matrix-based intra prediction samples predMip[x][y] with x=0 . . . predW−1, y=0 . . . predH−1, the transform block width nTbW, the transform block height nTbH, the upsampling boundary width upsBdryW, the upsampling boundary height upsBdryH, the top upsampling boundary samples upsBdryT, and the left upsampling boundary samples upsBdryL as inputs, and the output is the predicted sample array predSamples.
   Otherwise, predSamples[x][y], with x=0 . . . nTbW−1, y=0 . . . nTbH−1 is set equal to predMip[x][y].
4. The predicted samples predSamples[x][y] with x=0 . . . nTbW−1, y=0 . . . nTbH−1 are clipped as follows:

predSamples[x][y]=Clip1_{Y}(predSamples[x][y]) (8-71)

TABLE 8-8
Specification of weight shift sW depending on MipSizeId and modeId

| Mip | modeId | | | | | | | | | | | | | | | | | |
|---|---|---|---|---|---|---|---|---|---|---|---|---|---|---|---|---|---|---|
| SizeId | 0 | 1 | 2 | 3 | 4 | 5 | 6 | 7 | 8 | 9 | 10 | 11 | 12 | 13 | 14 | 15 | 16 | 17 |
| 0 | 8 | 8 | 8 | 8 | 8 | 8 | 8 | 8 | 8 | 8 | 8 | 8 | 8 | 8 | 8 | 8 | 8 | 8 |
| 1 | 8 | 8 | 8 | 9 | 8 | 8 | 8 | 8 | 9 | 8 | | | | | | | | |
| 2 | 8 | 8 | 8 | 8 | 8 | 8 | | | | | | | | | | | | |

With the proposed design, the draft text for the intra sample prediction process is changed as follows (where bold shows the steps added to the draft text, and the lined through shows the steps removed from the draft text):

For the intra sample prediction process according to predModeIntra, the following ordered steps apply:
1. The matrix-based intra prediction samples predMip[x][y], with x=0 . . . mipW−1, y=0 . . . mipH−1 are derived as follows:
   a. The variable modeId is derived as follows:

modeId=predModeIntra−(isTransposed ? numModes/2:0) (8-63)
b. The weight matrix mWeight[x][y] with x=0 . . . 2*boundarySize−1, y=0 . . . predC*predC−1 is derived using MipSizeId[xTbCmp][yTbCmp] and modeId as specified in Table 8-8
c. The bias vector vBias[y] with y=0 . . . predC*predC−1 is derived using sizeId and modeId as specified in Table 8-8.
d. The variable sW is derived using MipSizeId[xTbCmp][yTbCmp] and modeId as specified in Table 8-8.
e. The matrix-based intra prediction samples predMip[x][y], with x=0 . . . mipW−1, y=0 . . . mipH−1 are derived as follows:

i. oW=1<<(sW−1) (8-64)

ii. sB=BitDepth_{Y}−1 (8-65)

iii. incW=(predC>mipW) ? 2:1 (8-66)

iv. incH=(predC>mipH) ? 2:1 (8-67)

v. predMip[x][y]=Clip1_{Y}(

vi. ((Σᵢ₌₀^{2*boundarySize-1}mWeight[i][y*incH*predC+x*incW]*p[i])+(vBias[y*incH*predC+x*incW]<<sB)+oW)>>sW) (8-68)
2. When isTransposed is equal to TRUE, the predH×predW array predMip[x][y] with x=0 . . . predH−1, y=0 . . . predW−1 is transposed as follows:

a. predTemp[y][x]=predMip[x][y] (8-69)

b. predMip=predTemp (8-70)
3. The predicted samples predSamples[x][y], with x=0 . . . nTbW−1, y=0 . . . nTbH−1 are derived as follows:
   a. If needUpsBdryVer is equal to TRUE or needUpsBdryHor is equal to TRUE, the MIP prediction upsampling process as specified in clause 8.4.5.2.4 is invoked with the input block width predW, the input block height predH, matrix-based intra prediction samples predMip[x][y] with x=0 . . . predW−1, y=0 . . . predH−1, the transform block width nTbW, the transform block height nTbH, the upsampling boundary width upsBdryW, the upsampling boundary height upsBdryH, the top upsampling boundary samples upsBdryT, and the left upsampling boundary samples upsBdryL as inputs, and the output is the predicted sample array predSamples.
   b. Otherwise, predSamples[x][y], with x=0 . . . nTbW−1, y=0 . . . nTbH−1 is set equal to predMip[x][y].

[symbol]

[symbol]

[symbol]

[symbol]

[symbol]

TABLE 8-8
Specification of weight shift sW depending on MipSizeId and modeId

| Mip | modeId | | | | | | | | | | | | | | | | | |
|---|---|---|---|---|---|---|---|---|---|---|---|---|---|---|---|---|---|---|
| SizeId | 0 | 1 | 2 | 3 | 4 | 5 | 6 | 7 | 8 | 9 | 10 | 11 | 12 | 13 | 14 | 15 | 16 | 17 |
| 0 | 8 | 8 | 8 | 8 | 8 | 8 | 8 | 8 | 8 | 8 | 8 | 8 | 8 | 8 | 8 | 8 | 8 | 8 |
| 1 | 8 | 8 | 8 | 9 | 8 | 8 | 8 | 8 | 9 | 8 | | | | | | | | |
| 2 | 8 | 8 | 8 | 8 | 8 | 8 | | | | | | | | | | | | |

In another example, a down-sampled input from reference samples of the current block is generated, the down-sampled input to a matrix multiplication is applied, and offsets are optionally added to the output of the matrix multiplication, to obtain an output on a sparse grid at least sparse horizontally or sparse vertically or sparse in both directions. Then, a clipping operation is applied on at least one sample of the output that ensures that that sample value after clipping is greater than or equal to 0 and smaller than or equal to the maximum value allowed for a decoded picture. Then, a filter is applied that, based on at least one clipped output sample, interpolates at least one sample of the prediction of the current block, where the filter do not change the max or min value of any input samples.

In an alternative embodiment, clipping may be avoided altogether. Hence, all the steps above are followed except that step 12 (the clipping step) is removed. This means that the prediction can sometimes be out of the sample value range (smaller than 0 or larger than 2^{bitDepth}−1). Hence, an important aspect of the solution presented herein is that the decoder should be able to handle negative prediction values. After the prediction block has been calculated, the decoder can add a residual block. Since these residual values can already be negative, the reconstructed block (the prediction block plus the residual block) should anyway be able to handle negative values. However, an important aspect of the solution presented herein is that the decoder in this embodiment should be able to handle negative sample values in the reconstruction that may be of a larger magnitude than if clipping had been done. As an example, in prior art, the smallest number in the prediction was 0 (since clipping was performed), and the smallest number in the residual (i.e., the negative number with the largest magnitude) was −1023. Hence the smallest number in the reconstruction would be 0+(−1023)=−1023. However, in this embodiment, no clipping is taking place, and therefore the negative number with largest magnitude in the prediction may be −512 (or some other non-zero negative value). Hence the smallest possible value in the reconstruction would be (−1023)+(−512)=−1535. It is an important aspect of the solution presented herein that the decoder be able to handle a negative value with such a large magnitude in the reconstructed block. After the block has been reconstructed, it is clipped, just as it would have been if non-MIP reconstruction would have been used.

It is also an important aspect of the solution presented herein that the encoder should ensure that the decoder never ends up with a negative value that is of too large a magnitude. As an example, perhaps it is known that the reconstruction can handle negative values down to −1535 but not values smaller than this, such as −1536. This can be done, for instance, by avoiding a certain mode if it violates this rule. As an example, if the encoder calculates that selecting a certain MIP mode would give a reconstructed value of −1550 in one or more samples in the decoder, it can select a non-MIP mode, or quantize the coefficients less harsh.

It should be understood that while −512 has been used as the smallest allowed negative value in the decoder, this can be set to an arbitrary value, e.g., −2048 or −4000.

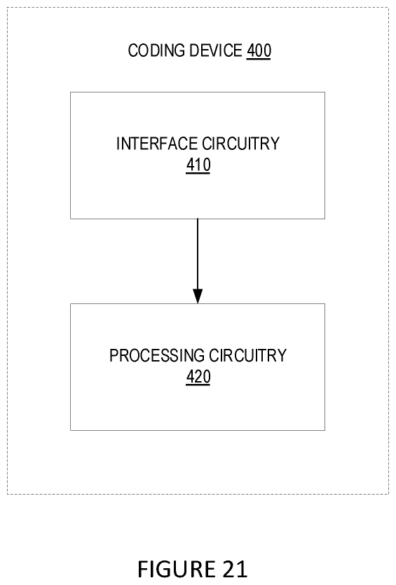

FIG. 21 shows a coding device 400 configured to perform encoding, decoding, or both as herein described. The coding device 400 comprises interface circuitry 410 and processing circuitry 420. The interface circuitry 410 enables the input and/or output of video signals and image signals. The input signals may comprises coded or un-encoded video signals or image signals. The output signals, similarly, may comprises un-encoded or coded video signals or image signals. The processing circuitry 420 is configured to perform video coding and/or decoding using MIP as herein described to produce the output signals from the input signals.

It will be appreciated that while the figures and the above description is presented in terms of various units, e.g., prediction unit, clipping unit, etc., each of the units disclosed herein may be implemented as a circuit, unit, and/or module.

Embodiments of the present disclosure provide techniques for reducing the computational complexity and latency of MIP without sacrificing coding efficiency. The techniques as herein described have negligible impact on coding performance compared to prior art techniques. The embodiments also reduce misalignment between boundary samples and the MMU output when MIP is used.

1-23. (canceled)

24. A method of intra-prediction associated with a current block, the method comprising:
deriving a reduced prediction matrix from input boundary samples adjacent the current block, the reduced prediction matrix having a number of prediction samples less than a size of a prediction block for the current block;
clipping each prediction sample in the reduced prediction matrix having a value outside a predetermined range to generate a clipped reduced prediction matrix; and
deriving the prediction block for the current block from the clipped reduced prediction matrix, the prediction block having a number of prediction samples equal to the size of the prediction block for the current block.

25. The method of claim 24, wherein the method of intra-prediction is part of an encoding process for generating an encoded block.

26. The method of claim 24, wherein the method of intra-prediction is part of a decoding process for determining a decoded block representative of the current block.

27. The method of claim 24, wherein the deriving the prediction block comprises interpolating the prediction samples using the clipped reduced prediction matrix to generate prediction samples at remaining positions of the prediction block to derive the prediction block.

28. The method of claim 24, wherein the deriving the reduced prediction matrix comprises:
down sampling the input boundary samples to generate a reduced set of boundary samples comprising a number of boundary samples less than a number of input boundary samples; and
deriving the reduced prediction matrix from the reduced set of boundary samples.

29. The method of claim 28, wherein the deriving the reduced prediction matrix comprises multiplying the reduced set of boundary samples by a matrix vector to generate the reduced prediction matrix having the number of prediction samples less than the size of the prediction block.

30. The method of claim 28, wherein the down sampling the input boundary samples comprises, for each of one or more boundary samples in the reduced set of boundary samples, selecting one of the input boundary samples as the boundary sample for the reduced set of boundary samples.

31. The method of claim 28, wherein the down sampling the input boundary samples comprises, for each of one or more boundary samples in the reduced set of boundary samples, averaging two or more input boundary samples to obtain the boundary sample for the reduced set of boundary samples.

32. The method of claim 25, further comprising:
subtracting the prediction block from the current block to generate a residual block;
determining an encoded block from the residual block; and
transmitting the encoded block to a receiver.

33. The method of claim 26, further comprising:
receiving an encoded block from a transmitter;
determining a residual block from the received encoded block; and
combining the residual block with the prediction block to determine a decoded block representative of the current block.

34. An intra-prediction apparatus for performing intra-prediction associated with a current block, the intra-prediction apparatus comprising:
a matrix multiplication unit (MMU) configured to generate a reduced prediction matrix from input boundary samples adjacent the current block, the reduced prediction matrix having a number of prediction samples less than the size of a prediction block for the current block;
a clipping unit configured to clip each prediction sample in the reduced prediction matrix having a value outside a predetermined range to generate a clipped reduced prediction matrix; and
an output unit configured to derive a prediction block for the current block from the clipped reduced prediction matrix, the prediction block having a number of prediction samples equal to the size of the prediction block for the current block.

35. The intra-prediction apparatus of claim 34, wherein the intra-prediction apparatus is part of an encoder configured to generate an encoded block.

36. The intra-prediction apparatus of claim 34, wherein the intra-prediction apparatus is part of a decoder configured to determine a decoded block representative of the current block.

37. The intra-prediction apparatus of claim 34, wherein the output unit comprises an interpolation circuit configured to interpolate the prediction samples using the clipped reduced prediction matrix to generate prediction samples at remaining positions of the prediction block to derive the prediction block.

38. The intra-prediction apparatus of claim 34:
further comprising a down sampling circuit configured to down sample the input boundary samples to generate a reduced set of boundary samples comprising a number of boundary samples less than a number of input boundary samples;
wherein the MMU is configured to generate the reduced prediction matrix from the reduced set of boundary samples.

39. The intra-prediction apparatus of claim 38, wherein the MMU derives the reduced prediction matrix by multiplying the reduced set of boundary samples by a matrix vector to generate the reduced prediction matrix having the number of prediction samples less than the size of the prediction block.

40. The intra-prediction apparatus of claim 38, wherein the down sampling circuit down samples the input boundary samples by, for each of one or more boundary samples in the reduced set of boundary samples, selecting one of the input boundary samples as the boundary sample for the reduced set of boundary samples.

41. The intra-prediction apparatus of claim 38, wherein the down sampling circuit down samples the input boundary samples by, for each of one or more boundary samples in the reduced set of boundary samples, averaging two or more input boundary samples to obtain the boundary sample for the reduced set of boundary samples.

42. The apparatus of claim 35:
a combiner configured to subtract the prediction block from the current block to generate a residual block; and
processing circuitry configured to determine an encoded block from the residual block for transmission by a transmitter.

43. The apparatus of claim 36, further comprising:
processing circuitry configured to determine a residual block from a received encoded block; and
a combiner configured to combine the residual block with the prediction block to determine a decoded block representative of the current block.

44. A non-transitory computer readable recording medium storing a computer program product for controlling an intra-prediction apparatus for performing intra-prediction associated with a current block, the computer program product comprising program instructions which, when run on processing circuitry of the intra-prediction apparatus, causes the intra-prediction apparatus to:
derive a reduced prediction matrix from input boundary samples adjacent the current block, the reduced prediction matrix having a number of prediction samples less than a size of a prediction block for the current block;
clip each prediction sample in the reduced prediction matrix having a value outside a predetermined range to generate a clipped reduced prediction matrix; and
derive the prediction block for the current block from the clipped reduced prediction matrix, the prediction block having a number of prediction samples equal to the size of the prediction block for the current block.

45. The computer readable recording medium of claim 44:
wherein the intra-prediction apparatus is part of an encoder configured to generate an encoded block;
wherein the instructions are such that the intra-prediction apparatus is further operative to:
subtract the prediction block from the current block to generate a residual block;
determine an encoded block from the residual block; and
transmit the encoded block to a receiver.

46. The computer readable recording medium of claim 44:
wherein the intra-prediction apparatus is part of a decoder configured to determine a decoded block representative of the current block.
wherein the instructions are such that the intra-prediction apparatus is further operative to:
receive an encoded block from a transmitter;
determine a residual block from the received encoded block; and
combine the residual block with the prediction block to determine a decoded block representative of the current block.
